(19) United States
(12) Patent Application Publication
(10) Pub. No.: US 2018/0273801 A1
(43) Pub. Date: Sep. 27, 2018

(54) ROSIN-CONTAINING MATERIALS AND METHODS OF MAKING THEREOF

(71) Applicant: Arizona Chemical Company, LLC, Jacksonville,, FL (US)

(72) Inventors: Rachel C. SEVERANCE, Savannah, GA (US); Tresha Ann OVERSTREET, Savannah, GA (US); Lloyd A. NELSON, Savannah, GA (US); Paul A. WILLIAMS, Savannah, GA (US); Lien H. PHUN, Savannah, GA (US)

(73) Assignee: Arizona Chemical Company, LLC, Jacksonville, FL (US)

(21) Appl. No.: 15/540,964

(22) PCT Filed: Dec. 16, 2015
(86) PCT No.: PCT/US2015/066094

§ 371 Date: Jun. 29, 2017

Related U.S. Application Data
(60) Provisional application No. 62/098,847, filed on Dec. 31, 2014.

(51) Int. Cl. C09F 1/02; C09F 1/04; C08L 93/04; C08L 91/00; C11B 13/00

(52) U.S. Cl. CPC C09F 1/02; C09F 1/04; C11B 13/005; C08L 91/00; C08L 93/04

(57) ABSTRACT

Provided herein are rosin-containing materials, including crude tall oil (CTO), tall oil rosin (TOR), distilled tall oil (DTO), crude fatty acid (CFA), as well as methods of making thereof. The rosin-containing materials can exhibit improved color (e.g., a reduced Gardner color), reduced sulfur content, improved color stability, or a combination thereof.

### TECHNICAL HELD

This application relates generally to rosin-containing materials, including crude tall oil (CTO) and tall oil fatty acid (TOFA), as well as methods of making thereof.

### BACKGROUND

Raw material feeds that come from the distillation of pine tall oil can have residual impurities that can result in undesired color and increased sulfur as a result of the Kraft paper making process. The ability to remove some of these impurities and excess sulfur could lead to a wider range of products with a more desirable functionality and appearance. The methods and compositions described herein address these and other needs.

### SUMMARY

Provided herein are methods of making rosin-containing materials, including crude tall oil (CTO), tall oil rosin (TOR), distilled tall oil (DTO), crude fatty acid (CFA), and tall oil fatty acid (TOFA). The rosin-containing materials can exhibit improved color (e.g., a reduced Gardner color), reduced sulfur content, improved color stability, or a combination thereof.

For example, provided herein are methods of improving the color stability of a rosin-containing material. Methods of improving the color stability of a rosin-containing material can comprise contacting the rosin-containing material with a mesoporous adsorbent to form a decolorized rosin-containing material. In some cases, the rosin-containing material can be maintained in contact with the mesoporous adsorbent for a period of time effective to reduce the neat Gardner color of the rosin-containing material by at least 20%. The resulting decolorized rosin-containing material can exhibit improved color stability relative to the same rosin-containing material not contacted with the mesoporous adsorbent. For example, the decolorized rosin-containing material can exhibit less than a 20% increase (e.g., less than a 10% increase) in Gardner color upon incubation at 23° C. for period of 7 days immediately following formation of the decolorized rosin-containing material.

Also provided are methods of reducing the color of a rosin-containing material. Methods of reducing the color of a rosin-containing material can comprise contacting the rosin-containing material with a mesoporous adsorbent to form a decolorized rosin-containing material. In some cases, the rosin-containing material can be maintained in contact with the mesoporous adsorbent for a period of time effective to reduce the neat Gardner color of the rosin-containing material by at least 20% (e.g., at least 40%). The resulting decolorized rosin-containing material can exhibit improved color stability relative to the same rosin-containing material not contacted with the mesoporous adsorbent. For example, the decolorized rosin-containing material can exhibit less than a 20% increase (e.g., less than a 10% increase) in Gardner color upon incubation at 23° C. for period of 7 days immediately following formation of the decolorized rosin-containing material.

Also provided are methods of reducing the sulfur content of a rosin-containing material. Methods of reducing the sulfur content of a rosin-containing material can comprise contacting the rosin-containing material with a mesoporous adsorbent to form a desulfurized rosin-containing material. In some cases, the rosin-containing material can be maintained in contact with the mesoporous adsorbent for a period of time effective to reduce the sulfur content of the rosin-containing material by at least 25% (e.g., by at least 40%).

In the methods described herein, the rosin-containing material can be contacted with the mesoporous adsorbent in any suitable fashion. For example, in some cases, the rosin-containing material and the mesoporous adsorbent can be combined to form a slurry. In certain cases, contacting the rosin-containing material with a mesoporous adsorbent can comprise flowing the rosin-containing material through a stationary phase comprising the mesoporous adsorbent. In some cases, the rosin-containing material can be flowed through the mesoporous adsorbent at an elevated temperature (e.g., 50-150° C.). In particular embodiments, the mesoporous adsorbent can be disposed within a fixed bed reactor. In these embodiments, the rosin-containing material can flowed through a volume of mesoporous adsorbent at a flow rate, wherein the volume of mesoporous adsorbent and the flow rate are effective to yield an empty bed contact time of 1.5 hours or more.

Any suitable mesoporous adsorbent can be used in the methods described above. In some embodiments, the mesoporous adsorbent can comprise a volume of mesopores of 0.2 mL/g or more (e.g., a volume of mesopores of 0.8 mL/g or more). In certain embodiments, the mesoporous adsorbent can comprise a volume of micropores of from 0.05 mL/g to 0.3 mL/g, a volume of macropores of from 0.1 mL/g to 0.6 mL/g, or a combination thereof.

In some cases, the mesoporous adsorbent can comprise an activated carbon (e.g., a wood-based chemically activated carbon). In certain cases, the activated carbon can comprise a powdered activated carbon. In certain cases, the activated carbon can comprise a granular activated carbon. In some embodiments, the activated carbon can comprise a blend of two or more activated carbons having different average pore sizes.

The methods described herein can further comprise subjecting the decolorized and/or desulfurized rosin-containing material to one or more additional process steps (e.g., one or more purification steps such as distillation and/or one or more reactions). For example, methods can further comprise subjecting the decolorized and/or desulfurized rosin-containing material to distillation. In one example embodiment, the rosin containing material can be CTO, the decolorized and/or desulfurized rosin-containing material can be decolorized and/or desulfurized CTO, and methods can further include subjecting the decolorized and/or desulfurized CTO to distillation to obtain TOR, DTO, CFA, TOFA, or a combination thereof. The TOR, DTO, CFA, TOFA, or a combination thereof obtained by these methods can exhibit improved color (e.g., a reduced Gardner color), reduced sulfur content, improved color stability, or a combination thereof. In some embodiments, methods can further comprise subjecting the decolorized and/or desulfurized rosin-containing material to and additional reaction (e.g., a reaction selected from the group consisting of esterification, disproportionation, hydrogenation, dimerization, and combinations thereof) to obtain a modified rosin. Such methods can be used to prepare, for example, rosin esters that exhibit improved color (e.g., a reduced Gardner color), reduced sulfur content, improved color stability, or a combination thereof.

Also provided are rosin-containing materials having improved color (e.g., a reduced Gardner color), reduced sulfur content, improved color stability, or a combination thereof. These rosin-containing materials can be prepared by the methods described herein.

For example, provided herein are compositions that comprise crude tall oil (CTO) having a neat Gardner color of 12 or less (e.g., a neat Gardner color of 10 or less) as determined according to the method described in ASTM D1544-04 (2010). The CTO can exhibit less than a 20% increase in Gardner color upon incubation at 23° C. for period of 7 days. In some cases, the CTO can have a sulfur content of 560 ppm of sulfur or less.

Also provided are compositions that comprise a tall oil fatty acid (TOFA) having a neat Gardner color of 3 or less (e.g., a neat Gardner color of 2 or less) as determined according to the method described in ASTM D1544-04 (2010). The TOFA can exhibit less than a 20% increase in Gardner color upon incubation at 23° C. for period of 7 days. In some cases, the TOFA can have a sulfur content of 40 ppm of sulfur or less.

In certain embodiments, the compositions can further comprise a mesoporous adsorbent, such as activated carbon, dispersed therein.

### DESCRIPTION OF FIGURES

FIG. 1 displays electron microscope images of (A) a chemically activated carbon and (B) a steam activated carbon.

FIG. 2 displays a comparison of the distribution of pore diameters and pore volumes resulting from various raw materials.

FIG. 3 displays the color improvement of TOFA samples versus activated carbon (CA1) content.

FIG. 4 displays the color improvement of CTO samples versus activated carbon (CA1) content.

FIG. 5 displays an image of the (left) control HYR sample and (right) treated HYR sample after 14 days from the scaled up HYR experiment.

FIG. 6 displays the sulfur content of CTO samples treated with 5% of various carbons.

FIG. 7 displays the sulfur content of CTO samples treated with loosely charged powdered activated carbons.

FIG. 8 displays the neat Gardner color values for CTO samples treated with 2.5% of CA1 and C-Gran.

FIG. 9 displays the Gardner color values for the small scale screening of wood-based activated carbons in CTO.

### DETAILED DESCRIPTION

Provided herein are methods of making rosin-containing materials, including crude tall oil (CTO), tall oil rosin (TOR), distilled tall oil (DTO), crude fatty acid (CFA), and tall oil fatty acid (TOFA). The rosin-containing materials can exhibit improved color (e.g., a reduced Gardner color), reduced sulfur content, improved color stability, or a combination thereof.

For example, provided herein are methods of improving the color stability of a rosin-containing material. Methods of improving the color stability of a rosin-containing material can comprise contacting the rosin-containing material with a mesoporous adsorbent to form a decolorized rosin-containing material. In some cases, the rosin-containing material can be maintained in contact with the mesoporous adsorbent for a period of time effective to reduce the neat Gardner color of the rosin-containing material by at least 20%. The resulting decolorized rosin-containing material can exhibit improved color stability relative to the same rosin-containing material not contacted with the mesoporous adsorbent. For example, the decolorized rosin-containing material can exhibit less than a 20% increase (e.g., less than a 10% increase) in Gardner color upon incubation at 23° C. for period of 7 days immediately following formation of the decolorized rosin-containing material.

Also provided are methods of reducing the color of a rosin-containing material. Methods of reducing the color of a rosin-containing material can comprise contacting the rosin-containing material with a mesoporous adsorbent to form a decolorized rosin-containing material. In some cases, the rosin-containing material can be maintained in contact with the mesoporous adsorbent for a period of time effective to reduce the neat Gardner color of the rosin-containing material by at least 20% (e.g., at least 40%). The resulting decolorized rosin-containing material can exhibit improved color stability relative to the same rosin-containing material not contacted with the mesoporous adsorbent. For example, the decolorized rosin-containing material can exhibit less than a 20% increase (e.g., less than a 10% increase) in Gardner color upon incubation at 23° C. for period of 7 days immediately following formation of the decolorized rosin-containing material.

Also provided are methods of reducing the sulfur content of a rosin-containing material. Methods of reducing the sulfur content of a rosin-containing material can comprise contacting the rosin-containing material with a mesoporous adsorbent to form a desulfurized rosin-containing material. In some cases, the rosin-containing material can be maintained in contact with the mesoporous adsorbent for a period of time effective to reduce the sulfur content of the rosin-containing material by at least 25% (e.g., by at least 40%).

Rosin, also called colophony or Greek pitch (Fix græca), is a solid hydrocarbon secretion of plants, typically of conifers such as pines (e.g., Pinus palustris and Pinus caribaea). Chemically, rosin can include a mixture of rosin acids, with the precise composition of the rosin varying depending in part on the plant species from which the rosin is obtained. Rosin acids are C₂₀ fused-ring monocarboxylic acids with a nucleus of three fused six-carbon rings containing double bonds that vary in number and location. Examples of rosin acids include abietic acid, neoabietic acid, dehydroabietic acid, dihydroabietic acid, pimaric acid, levopimaric acid, sandaracopimaric acid, isopimaric acid, and palustric acid.

Rosin-containing materials, including tall oil rosins, can be obtained as one of the by-products of what is known as the Kraft wood pulping process. Kraft wood pulping is a common process used in the pulp and paper industry in which wood chips are subjected to digestion in a pulping liquor at an elevated pressure and temperature. The pulping liquor (also known as white liquor) mainly consists of an aqueous solution of sodium hydroxide (NaOH) and sodium sulfide (Na₂S). This process liberates cellulose and lignin, and converts fatty acids and resin acids into water-soluble soaps. The resulting solution is known as black liquor. The black liquor is then concentrated (e.g. at reduced pressure) and treated with sulfuric acid (H₂SO₄) to form afford crude tall oil (CTO).

Rosin-containing materials include CTO as well as other rosin-containing materials obtainable by purification (e.g., distillation under reduced pressure, extraction, and/or crystallization) of CTO. CTO can be purified (e.g., distilled) to provide a variety of additional rosin-containing materials. For example, CTO can be distilled to provide a distillation fraction which is rich in resin acids, also referred to in the art as tall oil rosin (TOR). Other distillation fractions of CTO include tall oil fatty acid (TOFA), which is a fraction rich in fatty acids, and distilled tail oil (DTO), which is a fraction rich in a mixture of resin acids and fatty acids. Tall oil pitch is the residue of the distillation of CTO. Tall oil pitch can comprise alcohol esters of fatty acids and resin acids, oligomers of fatty and resin acids, phytosterols, hydrocarbons, and other components with high-boiling points.

Examples of commercially available tall oil rosins include SYLVAROS® 90 and SYLVAROS® NCY, commercially available from Arizona Chemical. Examples of commercially available tall oil fatty acids include SYLFAT™ products (e.g., SYLFAT™ 2, SYLFAT™ 2LTC, SYLFAT™ FA1, SYLFAT™ 2LT, and SYLFAT™ FA2) commercially available from Arizona Chemical. Examples of commercially available distilled tall oils include SYLVATAL™ products (e.g., SYLVATAL™ 10S, SYLVATAL™ 20/25S, SYLVATAL™ 20S, SYLVATAL™ 25/30S, SYLVATAL™ D25LR, SYLVATAL™ D30LR, and SYLVATAL™ D40LR) commercially available from Arizona Chemical.

Rosin-containing materials, including rosins, may be used as such in numerous applications, e.g., as tackifiers in adhesive applications (e.g. for tapes, labels, non-woven hygiene products and packaging), ink applications (e.g. as binders), paper sizing applications, road marking applications (e.g. as binders), tires and rubber applications (e.g. as emulsifiers, processing aids or traction resins). Rosin-containing materials can also be used as a source of rosin to obtain modified-rosin products such as hydrogenated rosin, disproportionated rosin, dimerized rosin, rosin esters, and other rosin derivatives such as salts of rosin (e.g. rosin soaps), rosin alcohols, rosin amides, rosin nitriles, rosin anhydrides, and Diels-Alder adducts of rosin.

The mesoporous adsorbent can be any suitable mesoporous material which can function as an adsorbent, and thereby improve the color, improve the color stability, and/or reduce the sulfur content of the rosin-containing material. A variety of mesoporous adsorbents are known in the art, and include activated carbon, metal oxides, such as alumina, zirconia, and silica, macroreticular ion exchange resins, zeolites, mesoporous clays, polymeric adsorbents, molecular sieves, and combinations thereof.

The mesoporous adsorbent can have a high surface area. In some embodiments, the mesoporous adsorbent can have a surface area of 500 m²/g or more (e.g., 600 m²/g or more, 700 m²/g or more, 800 m²/g or more, 900 m²/g or more, 1000 m²/g or more, 1100 m²/g or more, 1200 m²/g or more, 1300 m²/g or more, 1400 m²/g or more, 1500 m²/g or more, 1600 m²/g or more, 1700 m²/g or more, 1800 m²/g or more, or 1900 m²/g or more). In some embodiments, the mesoporous adsorbent can have a surface area of 2000 m²/g or less (e.g., 1900 m²/g or less, 1850 m²/g or less, 1800 m²/g or less, 1750 m²/g or less, 1700 m²/g or less, 1650 m²/g or less, 1600 m²/g or less, 1550 m²/g or less, 1500 m²/g or less, 1450 m²/g or less, 1400 m²/g or less, 1350 m²/g or less, 1300 m²/g or less, 1250 m²/g or less, 1200 m²/g or less, 1150 m²/g or less, 1100 m²/g or less, 1050 m²/g or less, 1000 m²/g or less, 950 m²/g or less, 900 m²/g or less, 850 m²/g or less, 800 m²/g or less, 750 m²/g or less, 700 m²/g or less, 650 m²/g or less, 600 m²/g or less, or 550 m²/g or less). The mesoporous adsorbent can have a surface area ranging from any of the minimum values described above to any of the maximum values described above. For example, the mesoporous adsorbent can have a surface area ranging from 500 m²/g to 2000 m²/g (e.g., from 750 m²/g to 2000 m²/g, from 1000 m²/g to 2000 m²/g, from 1000 m²/g to 1750 m²/g, or from 1000 m²/g to 1500 m²/g).

The mesoporous adsorbent can have varying porosity. The mesoporous adsorbent can include micropores (pores having a diameter <2 nm), mesopores (pores having a diameter of from 2 to 50 nm), macropores (pores having a diameter of >50 nm), or combinations thereof. The porosity of the mesoporous adsorbent can be characterized in terms of volume of micropores, volume of mesopores, volume of macropores, or combinations thereof present in the material.

In some embodiments, the mesoporous adsorbent can comprise a volume of mesopores of 0.2 mL/g or more (e.g., 0.25 mL/g or more, 0.3 mL/g or more, 0.35 mL/g or more, 0.4 mL/g or more, 0.45 mL/g or more, 0.5 mL/g or more, 0.55 mL/g or more, 0.6 mL/g or more, 0.65 mL/g or more, 0.7 mL/g or more, 0.75 mL/g or more, 0.8 mL/g or more, 0.85 mL/g or more, 0.9 mL/g or more, 0.95 mL/g or more, 1.0 mL/g or more, 1.05 mL/g or more, 1.10 mL/g or more, 1.15 mL/g, 1.20 mL/g or more, 1.3 mL/g or more, 1.4 mL/g or more, 1.5 mL/g or more, 1.6 mL/g or more, or 1.7 mL/g or more). In some embodiments, the mesoporous adsorbent can comprise a volume of mesopores of 1.75 mL/g or less (e.g., 1.7 mL/g or less, 1.6 mL/g or less, 1.5 mL/g or less, 1.4 mL/g or less, 1.3 mL/g or less, 1.20 mL/g or less, 1.15 mL/g or less, 1.10 mL/g or less, 1.05 mL/g or less, 1.0 mL/g or less, 0.95 mL/g or less, 0.9 mL/g or less, 0.85 mL/g or less, 0.8 mL/g or less, 0.75 mL/g or less, 0.7 mL/g or less, 0.65 mL/g or less, 0.6 mL/g or less, 0.55 mL/g or less, 0.5 mL/g or less, 0.45 mL/g or less, 0.4 mL/g or less, 0.35 mL/g or less, 0.3 mL/g or less, or 0.25 mL/g or less). The mesoporous adsorbent can comprise a volume of mesopores ranging from any of the minimum values above to any of the maximum values described above. For example, the mesoporous adsorbent can comprise a volume of mesopores ranging from 0.2 mL/g to 1.75 mL/g (e.g., from 0.2 mL/g to 0.95 mL/g, from 0.2 mL/g to 1.25 mL/g, from 0.95 mL/g to 1.75 mL/g, from 0.3 mL/g to 1.25 mL/g, from 0.75 mL/g to 1.25 mL/g, from 0.2 mL/g to 1.0 mL/g, or from 0.3 mL/g to 0.9 mL/g). In some embodiments, the mesoporous adsorbent can comprise a volume of mesopores of 0.8 mL/g or more.

In some embodiments, the mesoporous adsorbent can comprise a volume of micropores of 0.05 mL/g or more (e.g., 0.1 mL/g or more, 0.15 mL/g or more, 0.2 mL/g or more, 0.25 mL/g or more, 0.3 mL/g, 0.35 mL/g or more, 0.4 mL/g or more, 0.45 mL/g or more, 0.5 mL/g or more, 0.55 mL/g or more, 0.6 mL/g or more, 0.65 mL/g or more, 0.7 mL/g or more, 0.75 mL/g or more, 0.8 mL/g or more, or 0.85 mL/g or more). In some embodiments, the mesoporous adsorbent can comprise a volume of micropores of 0.9 mL/g or less (e.g., 0.85 mL/g or less, 0.8 mL/g or less, 0.75 mL/g or less, 0.7 mL/g or less, 0.65 mL/g or less, 0.6 mL/g or less, 0.55 mL/g or less, 0.5 mL/g or less, 0.45 mL/g or less, 0.4 mL/g or less, 0.35 mL/g or less, 0.3 mL/g or less, 0.25 mL/g or less, 0.2 mL/g or less, 0.15 mL/g or less, or 0.1 mL/g or less). The mesoporous adsorbent can comprise a volume of micropores ranging from any of the minimum values above to any of the maximum values described above. For example, the mesoporous adsorbent can comprise a volume of micropores ranging from 0.05 mL/g to 0.9 mL/g (e.g., from 0.05 to 0.3 mL/g, from 0.05 to 0.4 mL/g, from 0.3 mL/g to 0.9 mL/g, or from 0.1 mL/g to 0.3 mL/g).

In some embodiments, the mesoporous adsorbent can comprise a volume of macropores of 0.1 mL/g or more (e.g., 0.15 mL/g or more, 0.2 mL/g or more, 0.25 mL/g or more, 0.3 mL/g or more, 0.35 mL/g or more, 0.4 mL/g or more, 0.45 mL/g or more, 0.5 mL/g or more, 0.55 mL/g or more, 0.6 mL/g, 0.65 mL/g or more, 0.7 mL/g or more, 0.75 mL/g or more, 0.8 mL/g or more, 0.85 mL/g or more, 0.9 mL/g or more, 0.95 mL/g or more, 1 mL/g or more, 1.05 mL/g or more, 1.1 mL/g or more, or 1.15 mL/g or more). In some embodiments, the mesoporous adsorbent can comprise a volume of macropores of 1.2 mL/g or less (e.g., 1.15 mL/g or less, 1.1 mL/g or less, 1.05 mL/g or less, 1 mL/g or less, 0.95 mL/g or less, 0.9 mL/g or less, 0.85 mL/g or less, 0.8 mL/g or less, 0.75 mL/g or less, 0.7 mL/g or less, 0.65 mL/g or less, 0.6 mL/g or less, 0.55 mL/g or less, 0.5 mL/g or less, 0.45 mL/g or less, 0.4 mL/g or less, 0.35 mL/g or less, 0.3 mL/g or less, 0.25 mL/g or less, 0.2 mL/g or less, or 0.15 mL/g or less). The mesoporous adsorbent can comprise a volume of macropores ranging from any of the minimum values above to any of the maximum values described above. For example, the mesoporous adsorbent can comprise a volume of macropores ranging from 0.1 mL/g to 1.2 mL/g (e.g., from 0.1 mL/g to 0.6 mL/g, from 0.1 mL/g to 0.7 mL/g, from 0.6 mL/g to 1.2 mL/g, from 0.2 mL/g to 0.6 mL/g, or from 0.25 mL/g to 0.55 mL/g).

In some embodiments, the mesoporous adsorbent can comprise a greater volume of mesopores than volume of micropores or volume of macropores.

In some embodiments, the ratio of the volume of micropores in the mesoporous adsorbent to the volume of mesopores in the mesoporous adsorbent can be 1:10 or more (e.g., 1:9.5 or more, 1:9 or more, 1:8.5 or more, 1:8 or more, 1:7.5 or more, 1:7 or more, 1:6.5 or more, 1:6 or more, 1:5.5 or more, 1:5 or more, 1:4.5 or more, 1:4 or more, 1:3.5 or more, 1:3 or more, 1:2.5 or more, 1:2 or more, 1:1.5 or more, 1:1 or more, or 1.5:1 or more). In some embodiments, the ratio of the volume of micropores in the mesoporous adsorbent to the volume of mesopores in the mesoporous adsorbent can be 2:1 or less (e.g., 1.5:1 or less, 1:1 or less, 1:1.5 or less, 1:2 or less, 1:2.5 or less, 1:3 or less, 1:3.5 or less, 1:4 or less, 1:4.5 or less, 1:5 or less, 1:5.5 or less, 1:6 or less, 1:6.5 or less, 1:7 or less, 1:7.5 or less, 1:8 or less, 1:8.5 or less, 1:9 or less, or 1:9.5 or less). The ratio of the volume of micropores in the mesoporous adsorbent to the volume of mesopores in the mesoporous adsorbent can range from any of the minimum values described above to any of the maximum values described above, for example from 1:10 to 2:1 (e.g., from 1:4 to 2:1, from 1:4 to 1:2, from 1:2 to 2:1, or from 1.25 to 1:1).

In some embodiments, the ratio of the volume of mesopores in the mesoporous adsorbent to the volume of macropores in the mesoporous adsorbent can be 1:3.5 or more (e.g., 1:3 or more, 1:2 or more, 1:1 or more, 2:1 or more, 3:1 or more, 4:1 or more, 5:1 or more, 6:1 or more, 7:1 or more, 8:1 or more, 9:1 or more, 10:1 or more, 11:1 or more, or 12:1 or more). In some embodiments, the ratio of the volume of mesopores in the mesoporous adsorbent to the volume of macropores in the mesoporous adsorbent can be 12.5:1 or less (e.g., 12:1 or less, 11:1 or less, 10:1 or less, 9:1 or less, 8:1 or less, 7:1 or less, 6:1 or less, 5:1 or less, 4:1 or less, 3:1 or less, 2:1 or less, 1:1 or less, 1:2 or less, or 1:3 or less). The ratio of the volume of mesopores in the mesoporous adsorbent to the volume of macropores in the mesoporous adsorbent can range from any of the minimum values described above to any of the maximum values described above, for example from 1:3.5 to 12.5:1 (e.g., from 1:3.5 to 5:1, from 5:1 to 12.5:1, or from 1:1 to 10:1).

In some embodiments, the ratio of the volume of micropores in the mesoporous adsorbent to the volume of macropores in the mesoporous adsorbent can be 1:2 or more (e.g., 1:1.5 or more, 1:1 or more, 1.5:1 or more, 2:1 or more, 2.5:1 or more, 3:1 or more, or 3.5:1 or more). In some embodiments, the ratio of the volume of micropores in the mesoporous adsorbent to the volume of macropores in the mesoporous adsorbent can be 4:1 or less (e.g., 3.5:1 or less, 3:1 or less, 2.5:1 or less, 2:1 or less, 1.5:1 or less, 1:1 or less, or 1:1.5 or less). The ratio of the volume of micropores in the mesoporous adsorbent to the volume of macropores in the mesoporous adsorbent can range from any of the minimum values described above to any of the maximum values described above, for example from 1:2 to 4:1 (e.g., from 1:2 to 2:1, from 2:1 to 4:1, or from 1:1 to 3:1).

In some embodiments, the ratio of the volume of micropores in the mesoporous adsorbent to the volume of mesopores in the mesoporous adsorbent to the volume of macropores in the mesoporous adsorbent can be 1:4:2.

In certain embodiments, the mesoporous adsorbent can comprise an activated carbon. Activated carbon is a micro-crystalline, non-graphitic form of carbon which has been processed to develop a large internal surface area and pore volume. These characteristics, along with other variables including surface area and functional groups which render the surface chemically reactive, can be selected, as required, to influence the activated carbon's adsorptivity.

Suitable activated carbons can be produced from various carbonaceous raw materials using methods known in the art, each of which impart particular qualities to the resultant activated carbon. For example, activated carbons can be prepared from lignite, coal, bones, wood, peat, paper mill waste (lignin), and other carbonaceous materials such as nutshells. Activated carbons can be formed from carbonaceous raw materials using a variety of methods known in the art, including physical activation (e.g., carbonization of the carbonaceous raw material followed by oxidation, such as in steam activation) and chemical activation. In some embodiments, the activated carbon can comprise a wood-based chemically activated carbon.

A variety of forms of activated carbon can be used, including powdered activated carbon (PAC; a particulate form of activated carbon containing powders or fine granules of activated carbon less than 1.0 mm in size), granular activated carbon (GAC), extruded activated carbon (EAC; powdered activated carbon fused with a binder and extruded into a variety of shapes), bead activated carbon (BAC), and activated carbon fibers. Suitable forms of activated carbon can be selected in view of their desired level of adsorptivity as well as process considerations (e.g., ease of separation). Suitable activated carbons include wood PACs, such as NORIT® CA1, NORIT® CA3, DARCO® KB-G, and DARCO® KB-M; wood. GACs, such as NORIT® C GRAN; coal PACs, such as NORIT® PAC 200; coal GACs, such as NORIT® GAC 300; peat EACs, such as NORIT® Rox 0.8; lignite PACs, such as DARCO® S-51; lignite GACs, such as DARCO® 12x20; wood PACS, such as Exp 631; steam activated PACs derived from other carbon sources, such as DARCO® G-60; and GACs derived from other carbon sources, such as Exp 607, all of which are commercially available from Cabot Norit Americas, Inc. Other suitable activated carbons include coal PACs such as Calgon 12x40 commercially available from Calgon Carbon.

The ratio of the volume of micropores in the activated carbon to the volume of mesopores in the activated carbon to the volume of macropores in the activated carbon can be 1:4:2. In one embodiments, the activated carbon can comprise a chemically activated wood-based activated carbon having a volume of 0.2 mL/g of micropores, 0.8 mL/g of mesopores, and 0.4 mL/g macropores.

The ability of activated carbons to adsorb small and medium sized molecules can be quantitatively evaluated by measuring the methylene blue adsorption level of the activated carbon. In some embodiments, the activated carbon has a methylene blue absorption, measured in g/100 g, of 20 g/100 g or more (e.g., 21 g/100 g or more, 22 g/100 g or more, 23 g/100 g or more, 24 g/100 g or more, 25 g/100 g or more, 26 g/100 g or more, or 27 g/100 g or more). In some embodiments, the activated carbon has a methylene blue absorption of 28 g/100 g or less (e.g., 27 g/100 g or less, 26 g/100 g or less, 25 g/100 g or less, 24 g/100 g or less, 23 g/100 g or less, 22 g/100 g or less, or 21 g/100 g or less). The activated carbon can have a methylene blue absorption ranging from any of the minimum values described above to any of the maximum values described above. For example, the activated carbon can have a methylene blue absorption ranging from 20 g/100 g to 28 g/100 g (e.g., from 20 g/100 g to 25 g/100 g).

Activated carbons can exhibit varying surface chemistries. As a result of the manufacturing processes used to activate them, activated carbons can be alkaline, neutral, or acidic. In some embodiments, the activated carbon is acidic (i.e., the pH of a water extract of the activated carbon, as measured using the method described in ASTM D3838-05, is less than 7). In some embodiments, pH of a water extract of the activated carbon, as measured using the method described in ASTM D3838-05, is 8.0 or less (e.g., 7.5 or less, 7.0 or less, 6.5 or less, 6.0 or less, 5,5 or less, 5.0 or less, 4.5 or less, 4.0 or less, 3.5 or less, 3.0 or less, 2.5 or less, or 2.0 or less). In some embodiments, pH of a water extract of the activated carbon, as measured using the method described in ASTM D3838-05, is 1.5 or more (e.g., 2.0 or more, 2.5 or more, 3.0 or more, 3.5 or more, 4.0 or more, 4.5 or more, 5.0 or more, 5.5 or more, 6.0 or more, 6.5 or more, 7.0 or more, or 7.5 or more). The of water extract of the activated carbon, as measured using the method described in ASTM D3838-05, can range from any of the minimum values described above to any of the maximum values described above. For example, the pH of water extract of the activated carbon, as measured using the method described in ASTM D3838-05, can range from 1.5 to 8.0 (e.g., from 1.5 to 5.0, from 5.0 to 8.0, from 2.0 to 8.0, from 2.0 to 3.5, from 2.0 to 4.0, from 4.0 to 5,0, or from 4.0 to 7.0).

In some embodiments, the activated carbon can comprise a blend of two or more activated carbons having different average pore sizes.

The methods described herein can comprise contacting a rosin-containing material with the mesoporous adsorbent. The rosin-containing material can be contacted with the mesoporous adsorbent in any suitable fashion. For example, the rosin-containing material and the mesoporous adsorbent can be combined to form a slurry.

The mesoporous adsorbent can be present in the slurry in an amount of 0.01% by weight or more (e.g., 0.05% by weight or more, 0.1% by weight or more, 0.2% by weight or more, 0.3% by weight or more, 0.4% by weight or more, 0.5% by weight or more, 0.6% by weight or more, 0.7% by weight or more, 0.8% by weight or more, 0.9% by weight or more, 1% by weight or more, 1,5% by weight or more, 2% by weight or more, 2.5% by weight or more, 3% by weight or more, 3.5% by weight or more, 4% by weight or more, 4.5% by weight or more, 5% by weight or more, 6% by weight or more, 7% by weight or more, 8% by weight or more, 9% by weight or more, 10% by weight or more, 15% by weight or more, 20% by weight or more, or 25% by weight or more), based on the weight of the rosin-containing material present in the slurry. In some embodiments, the mesoporous adsorbent can be present in the slurry in an amount of 30% by weight or less (e.g., 25% by weight or less, 20% by weight or less, 15% by weight or less, 10% by weight or less, 9% by weight or less, 8% by weight or less, 7% by weight or less, 6% by weight or less, 5% by weight or less, 4.5% by weight or less, 4% by weight or less, 3.5% by weight or less, 3% by weight or less, 2.5% by weight or less, 2% by weight or less, 1.5% by weight or less, 1% by weight or less, 0.9% by weight or less, 0.8% by weight or less, 0.7% by weight or less, 0.6% by weight or less, 0.5% by weight or less, 0.4% by weight or less, 0.3% by weight or less, 0.2% by weight or less, 0.1% by weight or less, or 0.05% by weight or less), based on the weight of rosin-containing material present in the slurry.

The amount of mesoporous adsorbent present in the slurry can range from any of the minimum values described above to any of the maximum values described above, for example from 0.01% by weight to 30% by weight (e.g., from 0.05% by weight to 30% by weight, from 0.1% by weight to 25% by weight, from 0.01% by weight to 15% by weight, from 15% by weight to 30% by weight, from 0.01% by weight to 7% by weight, front 7% by weight to 15% by weight, or from. 5% by weight to 20% by weight), based on the weight of the rosin-containing material present in the slurry.

The rosin-containing material can be contacted with the mesoporous adsorbent for any amount of time sufficient to reduce the color of the rosin-containing material, improve the color stability of the rosin-containing material, reduce the sulfur content of the rosin-containing material, or a combination thereof. In some embodiments, the rosin-containing material can be contacted with the mesoporous adsorbent for 10 minutes or more (e.g., 15 minutes or more, 30 minutes or more, 45 minutes or more, 1 hour or more, 2 hours or more, 3 hours or more, 4 hours or more, 5 hours or more, 6 hours or more, 7 hours or more, 8 hours or more, 9 hours or more, 10 hours or more, 11 hours or more, 12 hours or more, 18 hours or more, 1 day or more, 2 days or more, 3 days or more, 4 days or more, 5 days or more, 6 days or more, 7 days or more, 8 days or more, 9 days or more, 10 days or more, 11 days or more, 12 days or more, 13 days or more, or 14 days or more).

In some embodiments, contacting the rosin-containing material with the mesoporous adsorbent can comprise flowing the rosin-containing material through a stationary phase comprising the mesoporous adsorbent (e.g., activated carbon). The stationary phase can be disposed within any suitable vessel so as to facilitate treatment of the rosin-containing material with the mesoporous adsorbent. In some cases, the stationary phase is disposed within a fixed bed reactor. The rosin-containing material can be flowed through the stationary phase under an inert atmosphere, such as a nitrogen atmosphere. Pressure can be applied to facilitate flow of rosin-containing material through the stationary phase, with the applied pressure being varied to control flow rate of the rosin-containing material thereof through the stationary phase. The stationary phase can comprise a single mesoporous adsorbent or a mixture of two or more mesoporous adsorbents. In certain embodiments, the stationary phase comprises a blend of two or more activated carbons having different average pore sizes. In some embodiments, the stationary phase comprises an activated carbon in combination with one or more additional components. For example, the stationary phase can further include an additional carbonaceous material (e.g., peat), an additional non-carbonaceous mesoporous adsorbent (e.g., silica, a zeolite, clay, alumina, molecular sieves, polymeric adsorbents, or combinations thereof), or combinations thereof.

The contact time of the rosin-containing material with the mesoporous adsorbent can be defined by calculation of the empty bed contact time (EBCT). The EBCT of the mesoporous adsorbent is defined by the formula below

$$EBCT = \frac{( 7.48 \times V )}{Q}$$

wherein EBCT is the empty bed contact time of the mesoporous adsorbent in minutes; V is the volume of the mesoporous adsorbent in cubic feet; and Q is the flow rate of rosin-containing material through the mesoporous adsorbent in gallons per minute. In some embodiments, the volume of the mesoporous adsorbent and the flow rate of rosin-containing material through the mesoporous adsorbent are effective to yield an empty bed contact time of 1.5 hours or more (e.g., 2 hours or more, 2.5 hours or more, 3 hours or more, 4 hours or more, 5 hours or more, 6 hours or more, 8 hours or more, 10 hours or more, 12 hours or more, 18 hours or more, or 24 hours or more).

In some embodiments, the rosin-containing material can be flowed through the mesoporous adsorbent at a flow rate effective to reduce the neat Gardner color of the rosin-containing material, as determined according to the method described in ASTM D1544-04 (2010). For example, in some embodiments, the rosin-containing material is flowed through the mesoporous adsorbent at a flow rate effective to reduce the neat Gardner color of the rosin-containing material by 10% or more (e.g., 15% or more, 20% or more, 25% or more, 30% or more, 35% or more, 40% or more, 45% or more, or 50% or more). In some cases, the rosin-containing material can be flowed through the mesoporous adsorbent at a flow rate effective to reduce the neat Gardner color of the rosin-containing material by 0.5 Gardner color units or more (e.g., 1.0 Gardner color units or more, 1.5 Gardner color units or more, 2 Gardner color units or more, 2.5 Gardner color units or more, 3 Gardner color units or more, 3.5 Gardner color units or more, 4 Gardner color units or more, 4.5 Gardner color units or more, 5 Gardner color units or more, 5.5 Gardner color units or more, 6 Gardner color units or more, 6.5 Gardner color units or more, 7 Gardner color units or more, 7.5 Gardner color units or more, 8 Gardner color units or more, or 8.5 Gardner color units or more) as determined according to the method described in ASTM D1544-04 (2010).

The rosin-containing material can be flowed through the mesoporous adsorbent at a flow rate effective to reduce the concentration of sulfur and/or sulfur containing compounds in the rosin-containing material. The sulfur content of the rosin-containing material can be measured with an ANTEK® 9000 sulfur analyzer using the standard methods described in ASTM D5453-05. For example, in some embodiments, the rosin-containing material is flowed through the mesoporous adsorbent at a flow rate effective to reduce the concentration of sulfur in the rosin-containing material by 10% or more (e.g., 15% or more, 20% or more, 25% or more, 30% or more, 35% or more, 40% or more, 45% or more, or 50% or more). In some embodiments, the rosin-containing material is flowed through the mesoporous adsorbent at a flow rate effective to reduce the concentration of sulfur in the rosin-containing material by 10 ppm or more (e.g., 20 ppm or more, 30 ppm or more, 40 ppm or more, 50 ppm or more, 60 ppm or more, 70 ppm or more, 80 ppm or more, 90 ppm or more, 100 ppm or more, 125 ppm or more, 150 ppm or more, 175 ppm or more, 200 ppm or more, 225 ppm or more, 250 ppm or more, 275 ppm or more, 300 ppm or more, 375 ppm or more, 400 ppm or more, 425 ppm or more, 450 ppm or more, 470 ppm or more, 500 ppm or more, 550 ppm or more, 600 ppm or more, 650 ppm or more, or 700 ppm or more).

Suitable flow rates for the rosin-containing material through the mesoporous adsorbent can be selected in view of a number of factors, including the desired properties of the rosin-containing material (e.g., the desired concentration of sulfur and/or sulfur containing compounds in the rosin-containing material, the desired Gardner color of the rosin-containing material, the desired color stability of the rosin-containing material, or combinations thereof), the properties of the rosin-containing material prior to contact with the mesoporous adsorbent (e.g., the concentration of sulfur and/or sulfur containing compounds in the rosin-containing material prior to contact with the mesoporous adsorbent, the Gardner color of the rosin-containing material prior to contact with the mesoporous adsorbent, the color stability of the rosin-containing material prior to contact with the mesoporous adsorbent, or combinations thereof), the desired empty bed contact time of the mesoporous adsorbent, the volume of the mesoporous adsorbent, and combinations thereof. In some embodiments, method can comprise measuring the Gardner color and/or the concentration of sulfur and/or sulfur containing compounds and/or the color stability of the rosin-containing material prior to contact with the mesoporous adsorbent and/or the Gardner color and/or the concentration of sulfur and/or sulfur containing compounds and/or the color stability of the rosin-containing material following contact with the mesoporous adsorbent, and adjusting the flow rate of the rosin-containing material through the mesoporous adsorbent until the desired reduction in Gardner color, the desired reduction in the concentration of sulfur and/or sulfur containing compounds, the desired color stability, or combination thereof is achieved.

In some embodiments, the resulting decolorized and/or desulfurized rosin-containing material can exhibit improved color stability relative to the same rosin-containing material not contacted with the mesoporous adsorbent. For example, in some embodiments, the decolorized and/or desulfurized rosin-containing material can exhibit less than a 20% increase (e.g., less than a 19% increase, less than a 18% increase, less than a 17% increase, less than a 16% increase, less than a 15% increase, less than a 14% increase, less than a 13% increase, less than a 12% increase, less than an 11% increase, less than a 10% increase, less than a 9% increase, less than an 8% increase, less than a 7% increase, less than a 6% increase, less than a 5% increase, less than a 4% increase, less than a 3% increase, less than a 2% increase, or less than a 1% increase) in Gardner color upon incubation at 23° C. for period of 7 days immediately following formation of the decolorized and/or desulfurized rosin-containing material.

In certain embodiments, the neat Gardner color of the decolorized and/or desulfurized rosin-containing material, as determined according to the method described in ASTM131544-04 (2010), can remain substantially unchanged (i.e., can exhibits less than a 0.5% change in neat Gardner color) upon incubation at 23° C. for period of 7 days immediately following formation of the decolorized and/or desulfurized rosin-containing material.

In some embodiments, the decolorized and/or desulfurized rosin-containing material exhibits a neat Gardner color change of less than 2 Gardner units e.g., a neat Gamer color change of less than 1.9 Gardner units, a neat Gamer color change of less than 1.8 Gardner units, a neat Gamer color change of less than 1.7 Gardner units, a neat Garner color change of less than 1.6 Gardner units, a neat Gamer color change of less than 1.5 Gardner units, a neat Garner color change of less than 1.4 Gardner units, a neat Garner color change of less than 1.3 Gardner units, a neat Garner color change of less than 12 Gardner units, a neat Gamer color change of less than 1.1 Gardner units, a neat Gamer color change of less than 1.0 Gardner units, a neat Garner color change of less than 0.9 Gardner units, a neat Garner color change of less than 0.8 Gardner units, a neat Garner color change of less than 0.7 Gardner units, a neat Gamer color change of less than 0.6 Gardner units, a neat Garner color change of less than 0.5 Gardner units, a neat Garner color change of less than 0.4 Gardner units, a neat Garner color change of less than 0.3 Gardner units, a neat Garner color change of less than 0.2 Gardner units, or a neat Garner color change of less than 0.1 Gardner units) as determined according to the method described in ASTM D1544-04 (2010), upon incubation at 23° C. for period of 7 days immediately following formation of the decolorized and/or desulfurized rosin-containing material.

In some embodiments, the rosin-containing material is contacted with the mesoporous adsorbent for an amount of time and/or at a concentration sufficient to reduce the neat Gardner color of the rosin-containing material, as determined according to the method described in ASTM D1544-04 (2010). For example, in some embodiments, the rosin-containing material is contacted with the mesoporous adsorbent for a time and/or at a concentration effective to reduce the neat Gardner color of the rosin-containing material by 10% or more (e.g., 15% or more, 20% or more, 25% or more, 30% or more, 35% or more, 40% or more, 45% or more, or 50% or more). The rosin-containing material can be contacted with the mesoporous adsorbent for an amount of time and/or at a concentration effective to reduce the neat Gardner color of the rosin-containing material by 0.5 Gardner color unit or more (e.g., 1.0 Gardner color units or more, 1.5 Gardner color units or more, 2 Gardner color units or more, 2.5 Gardner color units or more, 3 Gardner color units or more, 3.5 Gardner color units or more, 4 Gardner color units or more, 4.5 Gardner color units or more, 5 Gardner color units or more, 5.5 Gardner color units or more, 6 Gardner color units or more, 6.5 Gardner color units or more, 7 Gardner color units or more, 7.5 Gardner color units or more, 8 Gardner color units or more, or 8.5 Gardner color units or more) as determined according to the method described in ASTM D1544-04 (2010).

In some embodiments, the rosin-containing material can be contacted with the mesoporous adsorbent for an amount of time and/or at a concentration effective to reduce the concentration of sulfur and/or sulfur containing compounds in the rosin-containing material. The sulfur content of the rosin-containing material can be measured With an ANTEK® 9000 sulfur analyzer using the standard methods described in ASTM D5453-05. For example, in some embodiments, the rosin-containing material can be contacted with the mesoporous adsorbent for an amount of time and/or at a concentration effective to reduce the concentration of sulfur in the rosin-containing material by 10% or more (e.g., 15% or more, 2(>% or more, 25% or more, 30% or more, 35% or more, 40% or more, 45% or more, or 50% or more). In sonic embodiments, the rosin-containing material can be contacted with the mesoporous adsorbent for an amount of time and/or at a concentration effective to reduce the concentration of sulfur in the rosin-containing material by 10 ppm or more (e.g., 20 ppm or more, 30 ppm or more, 40 ppm or more, 50 ppm or more, 60 ppm or more, 70 ppm or more, 80 ppm or more, 90 ppm or more, 100 ppm or more, 125 ppm or more, 150 ppm or more, 175 ppm or more, 200 ppm or more, 225 ppm or more, 250 ppm or more, 275 ppm or more, 300 ppm or more, 375 ppm or more, 400 ppm or more, 425 ppm or more, 450 ppm or more, 470 ppm or more, 500 ppm or more, 550 ppm or more, 600 ppm or more, 650 ppm or more, or 700 ppm or more).

The methods described herein can further comprise subjecting the decolorized and/or desulfurized rosin-containing material to one or more additional process steps (e.g., distillation and/or one or more reactions). For example, methods can further comprise subjecting the decolorized and/or desulfurized rosin-containing material to distillation. In one example embodiment, the rosin containing material can be CTO, the decolorized and/or desulfurized rosin-containing material can be decolorized and/or desulfurized CTO, and methods can further include subjecting the decolorized and/or desulfurized CTO to distillation to obtain TOR, DTO, CFA, TOFA, or a combination thereof. The TOR, DTO, CFA, TOFA, or a combination thereof obtained by these methods can exhibit improved color (e.g., a reduced Gardner color), reduced sulfur content, improved color stability, or a combination thereof In some embodiments, methods can further comprise subjecting the decolorized and/or desulfurized rosin-containing material to and additional reaction (e.g., a reaction selected from the group consisting of esterification, disproportionation, hydrogenation, dimerization, and combinations thereof) to obtain a modified rosin. Such methods can be used to prepare, for example, rosin esters that exhibit improved color (e.g., a reduced Gardner color), reduced sulfur content, improved color stability, or a combination thereof.

Also provided are rosin-containing materials having improved color (e.g., a reduced Gardner color), reduced sulfur content, improved color stability, or a combination thereof. These rosin-containing materials can be prepared by the methods described herein.

For example, provided herein are compositions that comprise crude tall oil (CTO) having a neat Gardner color of 12 or less (e.g., 11.5 or less, 11 or less, 10.5 or less, 10 or less, 9.5 or less, 9 or less, 8.5 or less, 8 or less, 7.5 or less, 7 or less, 6.5 or less, 6 or less, 5.5 or less, 5 or less, 4.5 or less, 4 or less, 3.5 or less, 3 or less, 2.5 or less, 2 or less, 1.5 or less, 1 or less, or 0.5 or less) as determined according to the method described in ASTM D1544-04 (2010). In some embodiments, the compositions can have a neat Gardner color, as determined according to the method described in ASTM 1)1544-04 (2010), of 6 or more (e.g., 6.5 or more, 7 or more, 7.5 or more, 8 or more, 8.5 or more, 9 or more, 9.5 or more, 10 or more, 10.5 or more, 11 or more, or 11.5 or more). The neat Gardner color of the CTO compositions, as determined according to the method described in ASTM D1544-04 (2010), can range from any of the minimum values described above to any of the maximum values described above, for example from 6 to 12 (e.g., from 6 to 9, from 9 to 12, from 10 to 11, or from 10 to 12).

The CTO compositions can exhibit improved color stability. For example, in some embodiments, the CTO compositions can exhibit less than a 20% increase (e.g., less than a 19% increase, less than a 18% increase, less than a 17% increase, less than a 16% increase, less than a 15% increase, less than a 14% increase, less than a 13% increase, less than a 12% increase, less than an 11% increase, less than a 10% increase, less than a 9% increase, less than an 8% increase, less than a 7% increase, less than a 6% increase, less than a 5% increase, less than a 4% increase, less than a 3% increase, less than a 2% increase, or less than a 1% increase) in Gardner color upon incubation at 23° C. for period of 7 days.

In some cases, the CTO compositions can have a sulfur content of 560 ppm of sulfur or less (e.g., 550 ppm of sulfur or less, 52.5 ppm of sulfur or less, 500 ppm of sulfur or less, 475 ppm of sulfur or less, 450 ppm of sulfur or less, 425 ppm of sulfur or less, 400 ppm of sulfur or less, 375 ppm of sulfur or less, 350 ppm of sulfur or less, 325 ppm of sulfur or less, 300 ppm of sulfur or less, 275 ppm of sulfur or less, or 250 ppm of sulfur or less). In some embodiments, the CTO compositions can have a sulfur content of 250 ppm of sulfur or more (e.g., 275 ppm of sulfur or more, 300 ppm of sulfur or more, 325 ppm of sulfur or more, 350 ppm of sulfur or more, 375 ppm of sulfur or more, 400 ppm of sulfur or more, 425 ppm of sulfur or more, 450 ppm of sulfur or more, 475 ppm of sulfur or more, 500 ppm of sulfur or more, 525 ppm of sulfur or more, or 550 ppm of sulfur or more).

The sulfur content of the CTO compositions can range from any of the minimum values described above to any of the maximum values described above, for example from 250 ppm to 560 ppm (e.g., from 375 ppm to 500 ppm, or from 500 ppm to 560 ppm).

Also provided are compositions that comprise a tall oil fatty acid (TOFA) having a neat Gardner color of 3 or less (e.g., 2.9 or less, 2.8 or less, 2.7 or less, 2.6 or less, 2.5 or less, 2.4 or less, 2.3 or less, 2.2 or less, 2.1 or less, 2.0 or less, 1,9 or less, 1.8 or less, 1.7 or less, 1.6 or less, 1.5 or less, 1.4 or less, 1.3 or less, 1.2 or less, 1.1 or less, 1.0 or less, 0,9 or less, 0.8 or less, 0.7 or less, 0.6 or less, 0.5 or less, 0.4 or less, 0.3 or less, 0.2 or less, or 0.1 or less) as determined according to the method described in ASTM D1544-04 (2010). In some embodiments, the TOFA compositions can have a Gardner color, as determined according to the method described in ASTM D1544-04 (2010), of 0.1 or more (e.g., 0.2 or more, 0.3 or more, 0.4 or more, 0.5 or more, 0.6 or more, 0.7 or more, 0.8 or more, 0,9 or more, 1.0 or more, 1.1 or more, 1.2 or more, 1.3 or more, 1.4 or more, 1.5 or more, 1.6 or more, 1.7 or more, 1.8 or more, 1.9 or more, 2.0 or more, 2.1 or more, 2.2 or more, 2.3 or more, 2.4 or more, 2.5 or more, 2.6 or more, 2.7 or more, 2.8 or more, or 2.9 or more). The neat Gardner color of the TOFA compositions, as determined according to the method described in ASTM D1544-04 (2010), can range from any of the minimum values described above to any of the maximum values described above, for example from 0.1 to 3 (e.g., from 0.5 to 3, from 0.5 to 2, from 1 to 3, or from 1.5 to 3).

The TOFA compositions can exhibit improved color stability. For example, in sonic embodiments, the TOFA compositions can exhibit less than a 20% increase (e.g., less than a 19% increase, less than a 18% increase, less than a 17% increase, less than a 16% increase, less than a 15% increase, less than a 14% increase, less than a 13% increase, less than a 12% increase, less than an 11% increase, less than a 10% increase, less than a 9% increase, less than an 8% increase, less than a 7% increase, less than a 6% increase, less than a 5% increase, less than a 4% increase, less than a 3% increase, less than a 2% increase, or less than a 1% increase; in Gardner color upon incubation at 23° C. for period of 7 days.

In some embodiments, the TOFA compositions can have a sulfur content of 40 ppm of sulfur or less (e.g., 35 ppm of sulfur or less, 30 ppm of sulfur or less, 25 ppm of sulfur or less, 20 ppm of sulfur or less, 15 ppm of sulfur or less, 10 ppm of sulfur or less, 9 ppm of sulfur or less, 8 ppm of sulfur or less, 7 ppm of sulfur or less, 6 ppm of sulfur or less, 5 ppm of sulfur or less, 4 ppm of sulfur or less, 3 ppm of sulfur or less, 2 ppm of sulfur or less, or 1 ppm of sulfur or less). In some embodiments, the TOFA compositions can have a sulfur content of at least 0 ppm of sulfur (e.g., 1 ppm of sulfur or more, 2 ppm of sulfur or more, 3 ppm of sulfur or more, 4 ppm of sulfur or more, 5 ppm of sulfur or more, 6 ppm of sulfur or more, 7 ppm of sulfur or more, 8 ppm of sulfur or more, 9 ppm of sulfur or more, 10 ppm of sulfur or more, 15 ppm of sulfur or more, 20 ppm of sulfur or more, 25 ppm of sulfur or more, 30 ppm of sulfur or more, or 35 ppm of sulfur or more).

The sulfur content of the TOFA compositions can range from any of the minimum values described above to any of the maximum values described above, for example from 1 ppm to 40 ppm (e.g., from 15 ppm to 40 ppm, or from 20 ppm to 35 ppm).

In certain embodiments, the compositions can further comprise a mesoporous adsorbent, such as activated carbon, dispersed therein.

The decolorized and/or desulfurized rosin-containing materials prepared using the methods described herein can be used in a range of applications. For example, the decolorized and/or desulfurized rosin-containing materials can be used for metal working fluids (e.g., fluids that can be used to reduce heat and/or friction, and to remove metal particles in industrial machining and grinding operations), oil field chemicals, soaps, cleaners, alkyd resins, varnishes, dimer acids, surfactants, lubricants, fortified rosins, paper size and ink resins, rubbers, coatings, pavement additives, and adhesives, among others. In some embodiments, the decolorized and/or desulfurized rosin-containing materials prepared using the methods described herein can be used to prepare rosin esters, for example by esterifying the rosin with an alcohol to form a rosin ester.

In some embodiments, the decolorized and/or desulfurized rosin-containing materials prepared using the methods described herein can be incorporated into polymeric compositions, for example, as a tackifier. Polymeric compositions can include a decolorized and/or desulfurized rosin-containing material and a polymer derived from one or more ethylenically-unsaturated monomers. In this context, a polymer derived from an ethylenically-unsaturated monomer includes polymers derived, at least in part, from polymerization of the ethylenically-unsaturated monomer. For example, a polymer derived from an ethylenically-unsaturated monomers can be obtained by, for example, radical polymerization of a monomer mixture comprising the ethylenically-unsaturated monomer. A polymer derived from an ethylenically-unsaturated monomer can be said to contain monomer units obtained by polymerization (e.g., radical polymerization) of the ethylenically-unsaturated monomer. Polymeric compositions can also comprise a decolorized and/or desulfurized rosin-containing material described herein and a blend of two or more polymers derived from one or more ethylenically-unsaturated monomers. In these cases, the blend of two or more polymers can be, for example, a blend of two or more polymers having different chemical compositions (e.g., a blend of poly(ethylene-co-vinyl acetate) and polyvinyl acetate; or a blend of two poly(ethylene-co-vinyl acetates) derived from different weight percents of ethylene and vinyl acetate monomers).

The polymer can be a homopolymer or a copolymer (e.g., a random copolymer or a block copolymer) derived from one or more ethylenically-unsaturated monomers. In other words, the homopolymer or copolymer can include monomer units of one or more ethylenically-unsaturated monomers. The polymer can be a branched polymer or copolymer. For example, polymer can be a graft copolymer having a polymeric backbone and a plurality of polymeric side chains grafted to the polymeric backbone. In some cases, the polymer can be a graft copolymer having a backbone of a first chemical composition and a plurality of polymeric side chains which are structurally distinct from the polymeric backbone (e.g., having a different chemical composition than the polymeric backbone) grafted to the polymeric backbone.

Examples of suitable ethylenically-unsaturated monomers include (meth)acrylate monomers, vinyl aromatic monomers (e.g., styrene), vinyl esters of a carboxylic acids, (meth)acrylonitriles, vinyl halides, vinyl ethers, (meth)acrylamides and (meth)acrylamide derivatives, ethylenically unsaturated aliphatic monomers (e.g., ethylene, butylene, butadiene), and combinations thereof As used herein, the term “(meth)acrylate monomer” includes acrylate, methacrylate, diacrylate, and dimethacrylate monomers. Similarly, the term “(meth)acrylonitrile” includes acrylonitrile, methacrylonitrile, etc. and the term “(meth)acrylamide” includes acrylamide, methacrylamide, etc.

Suitable (meth)acrylate monomers include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C₁-C₂₀, C₁-C₁₂, C₁-C₈, or C₁-C₄ alkanols). Exemplary (meth)acrylate monomers include, but are not limited to, methyl acrylate, methyl (meth)acrylate, ethyl acrylate, ethyl (meth)acrylate, butyl acrylate, butyl (meth)acrylate, isobutyl (meth)acrylate, n-hexyl (meth)acrylate, ethylhexyl (meth)acrylate, n-heptyl (meth)acrylate, ethyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, acetoacetoxyethyl (meth)acrylate, acetoacetoxypropyl (meth)acrylate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-ethylhexyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, hydroxypropyl (meth)acrylate, methylpolyglycol (meth)acrylate, 3,4-epoxycyclohexylmethyl(meth)acrylate, 1,6 hexanediol di(meth)acrylate, 1,4 butanediol di(meth)acrylate and combinations thereof.

Suitable vinyl aromatic compounds include styrene, α- and p-methylstyrene, α-butylstyrene, 4-n-butylstyrene, 4-n-decylstyrene, vinytoluene, and combinations thereof. Suitable vinyl esters of carboxylic acids include vinyl esters of carboxylic acids comprising up to 20 carbon atoms, such as vinyl laurate, vinyl stearate, vinyl propionate, versatic acid vinyl esters, and combinations thereof. Suitable vinyl halides can include ethylenically unsaturated compounds substituted by chlorine, fluorine, bromine, or iodine, such as vinyl chloride, vinyl iodide, and vinylidene chloride. Suitable vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 2 to 8 carbon atoms and one olefinic double bond, such as ethylene, as well as hydrocarbons having 4 to 8 carbon atoms and two olefinic double bonds, such as butadiene, isoprene, and chloroprene.

In some embodiments, the polymer derived from one or more ethylenically-unsaturated monomers comprises a copolymer of ethylene and n-butyl acrylate. In some embodiments, the polymer derived from one or more ethylenically-unsaturated monomers comprises a copolymer of styrene and one or more of isoprene and butadiene. In certain embodiments, the polymer derived from one or more ethylenically-unsaturated monomers comprises a metallocene-catalyzed polyolefin. Examples of suitable metallocene-catalyzed polyolefins include metallocene polyethylenes and metallocene polyethylene copolymers, which are commercially available, for example, from Exxon Mobil Corporation (under the trade name EXACT®) and Dow Chemical Company (under the trade name AFFINITY®).

In certain embodiments, the polymer derived from one or more ethylenically-unsaturated monomers comprises a polymer derived from vinyl acetate. Polymers derived from vinyl acetate include polymers derived, at least in part, from polymerization of vinyl acetate monomers. For example, the polymer derived from vinyl acetate can be a homopolymer of vinyl acetate (i.e., polyvinyl acetate; PVA). The polymer derived from vinyl acetate can also be a copolymer of vinyl acetate and one or more additional ethylenically-unsaturated monomers (e.g., polyethylene-co-vinyl acetate), EVA). In these embodiments, the polymer derived from vinyl acetate can be derived from varying amounts of vinyl acetate, so as to provide a polymer having the chemical and physical properties suitable for a particular application.

In some cases, the polymeric composition can be an adhesive formulation (e.g., hot-melt adhesive formulation), an ink formulation, a coating formulation, a rubber formulation, a sealant formulation, an asphalt formulation, or a pavement marking formulation (e.g., a thermoplastic road marking formulation).

In certain embodiments, the composition is a hot-melt adhesive. In these embodiments, the decolorized and/or desulfurized rosin-containing material can function as all or a portion of the tackifier component in a traditional hot-melt adhesive formulation. The polymer derived from one or more ethylenically-unsaturated monomers (e.g., a polymer derived from vinyl acetate such as EVA), the decolorized and/or desulfurized rosin-containing material, and one or more additional components, can be present in amounts effective to provide a hot-melt adhesive having the characteristics required for a particular application. For example, the polymer derived from one or more ethylenically-unsaturated monomers (e.g., a polymer derived from vinyl acetate such as EVA), can be from 10% by weight to 60% by weight of the hot-melt adhesive composition (e.g., from 20% by weight to 60% by weight of the hot-melt adhesive composition, from 25% by weight to 50% by weight of the hot-melt adhesive composition, or from 30% by weight to 40% by weight of the hot-melt adhesive composition). The decolorized and/or desulfurized rosin-containing material can be from 20% by weight to 50% by weight of the hot-melt adhesive composition (e.g., from 25% by weight to 45% by weight of the hot-melt adhesive composition, or from 30% by weight to 40% by weight of the hot-melt adhesive composition).

The hot-melt adhesive can further include one or more additional components, including additional tackifiers, waxes, stabilizers (e.g., antioxidants and UV stabilizers), plasticizers (e.g., benzoates and phthalates), paraffin oils, nucleating agents, optical brighteners, pigments dyes, glitter, biocides, flame retardants, anti-static agents, anti-slip agents, anti-blocking agents, lubricants, and fillers. In some embodiments, the hot-melt adhesive further comprises a wax. Suitable waxes include paraffin-based waxes and synthetic Fischer-Tropsch waxes. The waxes can be from 10% by weight to 40% by weight of the hot-melt adhesive composition, based on the total weight of the composition (e.g., from 20% by weight to 30% by weight of the hot-melt adhesive composition).

In certain embodiments, the composition is a hot-melt adhesive and the polymer derived from one or more ethylenically-unsaturated monomers is EVA. In certain embodiments, the EVA can be derived from 10% by weight to 40% by weight vinyl acetate, based on the total weight of all of the monomers polymerized to form the EVA (e.g., from 17% by weight to 34% by weight vinyl acetate).

In certain embodiments, the composition is a thermoplastic road marking formulation. The thermoplastic road marking formulation can include from 5% by weight to 25% by weight of the decolorized and/or desulfurized rosin-containing material, based on the total weight of the thermoplastic road marking formulation (e.g., from 10% by weight to 20% by weight of the thermoplastic road marking formulation). The thermoplastic road marking formulation can further include a polymer derived from one or more ethylenically-unsaturated monomers (e.g., a polymer derived from vinyl acetate such as EVA) which can be, for example, from 0.1% by weight to 1.5% by weight of the thermoplastic road marking formulation. The thermoplastic road marking formulation can further include a pigment (e.g., from 1% by weight to 10% by weight titanium dioxide), and glass beads (e.g., from 30% by weight to 40% by weight), and a filler (e.g., calcium carbonate which can make up the balance of the composition up to 100% by weight). The thermoplastic road marking formulation can further include an oil (e.g., from 1% by weight to 5% by weight percent mineral oil), a wax (e.g., from 1% by weight to 5% by weight percent paraffin-based wax or synthetic Fischer-Tropsch wax), a stabilizer (e.g., from 0.1% by weight to 0.5% by weight stearic acid), and, optionally, additional polymers and/or binders other than the decolorized and/or desulfurized rosin-containing material.

In some embodiments, by incorporating the decolorized and/or desulfurized rosin-containing material prepared using the methods described herein into the polymeric composition, the polymeric composition can exhibit improved thermal stability, including improved viscosity stability on aging at elevated temperatures (thermal aging), improved color stability on thermal aging, or combinations thereof.

The polymeric compositions provided herein can be used in a variety of applications, including as adhesives (e.g., hot-melt adhesives), inks, coatings, rubbers, sealants, asphalt, and thermoplastic road markings and pavement markings. In some embodiments, the compositions are hot-melt adhesives used, for example, in conjunction with papers and packaging (e.g., to adhere surfaces of corrugated fiberboard boxes and paperboard cartons during assembly and/or packaging, to prepare self-adhesive labels, to apply labels to packaging, or in other applications such as bookbinding), in conjunction with non-woven materials (e.g., to adhere nonwoven material with a backsheet during the construction of disposable diapers), in adhesive tapes, in apparel (e.g., in the assembly of footwear, or in the assembly of multi-wall and specialty handbags), in electrical and electronic bonding (e.g., to affix parts or wires in electronic devices), in general wood assembly (e.g., in furniture assembly, or in the assembly of doors and mill work), and in other industrial assembly (e.g., in the assembly of appliances). The decolorized and/or desulfurized rosin-containing material prepared using the methods described herein can also be used in a variety of additional applications, including as a softener and plasticizer in chewing gum bases, as a weighting and clouding agent in beverages (e.g., citrus flavored beverages), as a surfactant, surface activity modulator, or dispersing agent, as an additive in waxes and wax-based polishes, as a modifier in cosmetic formulations (e.g., mascara), and as a curing agent in concrete.

By way of non-limiting illustration, examples of certain embodiments of the present disclosure are included below.

### EXAMPLES

General Methods

All materials were characterized using the following methods unless otherwise stated. Acid numbers were determined according to method described in ASTM D465-05 (2010) entitled “Standard Test Methods for Acid Number of Naval Stores Products Including Tall Oil and Other Related Products,” which is incorporated herein by reference in its entirety. The acid number is expressed as mg KOH per gram of sample. The Gardner color of all materials was measured according to the Gardner Color scale as specified in ASTM D1544-04 (2010) entitled “Standard Test Method for Color of Transparent Liquids (Gardner Color Scale),” which is incorporated herein by reference in its entirety. Gardner colors were measured using a Dr Lange LICO® 200 colorimeter. Unless otherwise indicated, all Gardner colors were measured using neat samples. Sulfur content was measured according to the standard methods described ASTM D5453-05 entitled “Standard Test Method for Determination of Total Sulfur in Light Hydrocarbons, Motor Fuels and Oils by Ultraviolet Fluorescence,” which is incorporated herein by reference in its entirety. Sulfur content was measured using an ANTEK® 9000 sulfur analyzer.

Overview

Raw material feeds that come from the distillation of pine tall oil can have residual impurities that can result in undesired color and increased sulfur as a result of the Kraft paper making process. The ability to remove some of these impurities and excess sulfur could lead to a wider range of products with a more desirable functionality and appearance.

Activated carbon is a pure, amorphous form of carbon with randomly cross-linked basal plane stacks which are heavily enveloped in unpaired electrons. These properties, along with the uneven stacking of the basal planes, can result in a highly porous structure with a large internal surface area with numerous cracks and crevices. Activated carbon can therefore be an effective material for adsorption of a wide variety of molecules.

Activated carbon can be used to remove impurities through the process of adsorption. Adsorption is the adhesion of molecules, or adsorbate, onto a surface known as the adsorbent. A variety of factors can influence a material's ability to adsorb onto a surface including carbon pore structure, surface complexities and chemistry, diffusion effects, and the type and concentration of the adsorbate. The process of adsorption can begin with the initial contact of the adsorbate with the external surface of the adsorbent. Adsorbates then can diffuse into the internal pore structure where they can be held by chemical or electrostatic forces of attraction. Chemical adsorption can involve chemical bonds between the adsorbate and the surface of the adsorbent, but can also include any relatively strong forces of attraction. Electrostatic, or physical, adsorption can involve relatively weak forces of attraction, such as van der Waals forces.

The types of impurities present in a material can vary widely, and can affect which activated carbon is most effective. Powdered activated carbons (PAC), granular activated carbons (GAC) and extruded carbons all differ in pore structure and size and therefore can yield varying results when tested against the same adsorbents. Also, carbon can be produced from a variety of raw materials including, for example, bituminous coal, lignite coal, peat, and wood. These raw materials can affect the internal structure and, by extension, the effectiveness of each carbon as an adsorbent.

Activation of carbon can occur by one of two processes: chemical or steam activation. Chemical activation can comprise mixing a cellulose-based material with a strong dehydrating agent and heating to a pre-determined temperature. Dehydrating agents such as phosphoric acid, sulfuric acid, and zinc oxide not only remove moisture but also can help maintain the internal pore structure by preventing the cellulose material from collapsing during activation. Extraction can then remove the activating agent from the carbon. This process can result in a highly developed structure with a high micropore content, very high mesopore content, and high macropore content. IUPAC standards designate micropores as having diameters less than 2 nm, mesopores as having diameters of 2-50 nm, and macropores as having diameters greater than 50 nm.

Steam activation is a two-step process involving carbonization and then activation. Carbonization can occur at high temperatures in a low oxygen environment and can result in the raw material being converted into a disordered carbon structure with a low volatile content. During activation, high temperature steam can react with the carbon to from carbon monoxide and hydrogen gas, which can then be burned to produce heat to maintain the activation process over time (Equation 1). Micropores are formed initially during steam activation, but prolonged activation times can result in higher mesopore and macropore structures. However, impurities in the raw material can affect the formation of pores and result in more macropores. Additional processes can be applied to the steam activation of certain carbons that can result in extruded carbons that are denser and have a different pore size distributions.

C₍ₛ₎+H₂O_{(g)}→CO_{(g)}+H_{2(g)} (1)

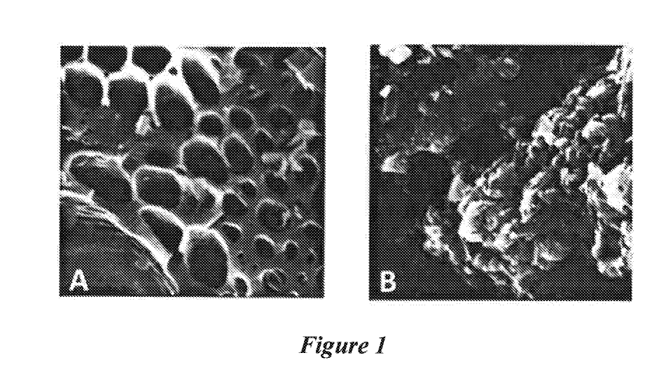

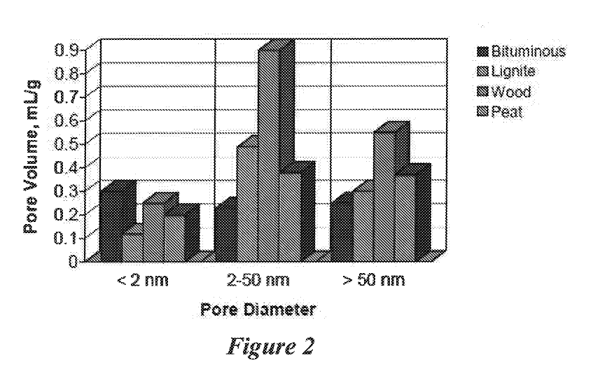

The structural differences between a chemically activated carbon and a steam activated carbon can be seen, for example, in FIG. 1. The pore size distributions for different activations of various raw materials are summarized in Table 1 and FIG. 2.

TABLE 1
Summary of pore size distribution from
activation of various raw materials.

| | | Pore Structure | | |
|---|---|---|---|---|
| Raw Material | Activation | Micro | Meso | Macro |
| Bituminous Coal | Steam | High | Low | Medium |
| Lignite Coal | Steam | Medium | High | High |
| Peat | Steam | High | Medium | High |
| Wood | Chemical | High | Very High | High |

### Example 1

Discussed herein are experiments that demonstrated that tall oil fatty acids (TOFA) treated with an activated carbon can yield a product with a lighter color, lower odor, and lower sulfur content. Specifically, in situ slurries of tall oil fatty acid (TOFA) with varying amounts of a chemically activated, wood-based carbon adsorbent were formed. The activated carbon was Norit CA1, which has a pH between 2 and 5, a micropore content of at least 0.2 mL/g, a. mesopore content of at least 0.8 mL/g, and a macropore content of at least 0.41 mL/g. Contact between the CA1 and the TOFA was for 1 hour or less, as a slurry at room temperature under open atmosphere. The results are summarized in Table 2. All treatments with any amount of CA1 resulted in a reduction in color and sulfur content.

TABLE 2
Summary of Gardner Color and sulfur content changes
for TOFA contacted with various amounts of CA1.

| | Color | Δ Color | Sulfur | Δ Sulfur |
|---|---|---|---|---|
| Material* | (Gardner) | (Gardner) | (ppm) | (ppm) |
| TOFA | 4.4 | — | 44 | — |
| TOFA, 0.1% CA1 | 4.0 | 0.4 | — | — |
| TOFA, 0.5% CA1 | 3.6 | 0.8 | — | — |
| TOFA, 2% CA1 | 2.4 | 2.0 | 32 | 27% |
| TOFA, 5% CA1 | 1.6 | 2.8 | 24 | 45% |
| TOFA, 10% CA1 | 0.9 | 3.5 | <10 | >77% |

*Percentages of CA1 are for the overall slurry (e.g., “TOFA, 2% CA1” means the slurry contained 2% CA1)

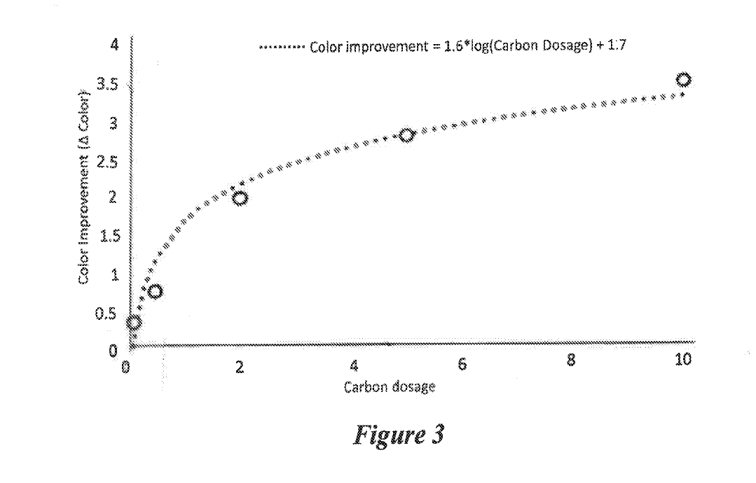

Based on the data in Table 2, the color improvement versus CA1 content can be represented by the curve shown in FIG. 3. Accordingly, a carbon dosage of 0.4% can give an improvement of ˜1 Gardner, 1.5% for ˜2 Gardner, and 6.5% for ˜3 Gardner.

The primary benefit in raising dosage of the CA1 is kinetic, as raising dosage gave diminishing returns (Table 2). Given sufficient time, lower dosages of both powdered (slurry) and granular carbon (fixed bed or static exposure) can provide results within 1-2 Gardner units.

### Example 2

Discussed herein are experiments that demonstrated that tall oil fatty acids (TOFA), tall oil rosin (TOR), and derivatives thereof treated with activated carbon can yield products with lighter color, lower odor, and lower sulfur content. When crude tall oil (CTO) was treated with adsorbents prior to distillation; color, sulfur, and odor body and body precursors were removed, translating into improved TOFA and TOR.

Specifically, in situ slurries of crude tall oil with varying amounts of a wood-based, chemically activated, high mesoporous content carbon were formed. The activated carbon was Norit CA1, which had pH between 2 and 5, a micropore content of at least 0.2 mL/g, a mesopore content of at least 0.8 mL/g, and a macropore content of at least 0.41 mL/g. Contact between the CA1 and the CTO was for 4 hours or less, as a slurry at 50° C., under an inert nitrogen atmosphere.

A control CTO sample was heated and placed through the same polishing filter as the treated materials to verify that any improvements were based on the activated carbon alone. Unfiltered CTO yielded a sulfur content of 1110 ppm, filtered CTO yielded a sulfur content of 1006 ppm, and CTO held at 50° C. under inert nitrogen atmosphere then filtered yielded a sulfur content of 979 ppm. Color was 18+ for all.

The results of treating CTO with various amount of CA1 are summarized in Table 3. All treatments with any amount of CA1 resulted in a reduction in color and sulfur content.

TABLE 3
Summary of Gardner Color and sulfur content changes
for CTO contacted with various amounts of CA1.

| | Color | Δ Color | Sulfur | Δ Sulfur |
|---|---|---|---|---|
| Material* | (Gardner) | (Gardner) | (ppm) | (ppm) |
| CTO | >18 | — | 979 | — |
| CTO, 10% CA1 | 11.9 | 7.1 | 557 | 43% |
| CTO, 20% CA1 | 10.2 | 7.8 | 455 | 54% |
| CTO, 30% CA1 | 9.1 | 8.9 | 289 | 70% |

*Percentages of CA1 are for the overall slurry (e.g., “CTO, 10% CA1” means the slurry contained 10% CA1)

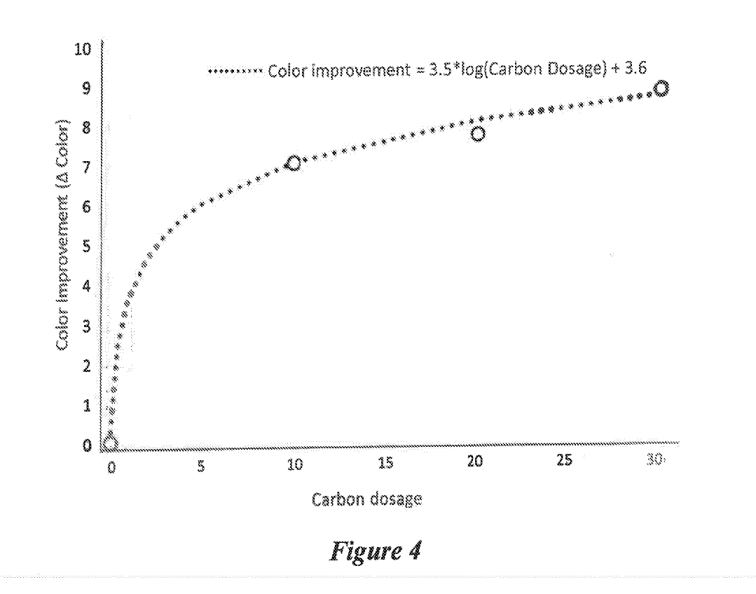

Based on the data in Table 3, the color improvement versus CA1 content can be represented by the curve shown in FIG. 4. Accordingly, a carbon dosage of 0.2% can give an improvement of ˜1. Gardner, 0.5% for ˜2.5 Gardner, 2.5% for ˜5 Gardner, and 4.8% for ˜6 Gardner.

Improved results were derived from increasing the contact time for the slurry to overnight (nitrogen atmosphere, 50° C). Agitation of the slurry also improved the results. Agitation gave greater improvements than temperature, with temperature primarily providing a kinetic benefit (4 hours of contact time versus overnight), whereas at room temperature improvement is not seen,

Next, the effect of the dosage amount of CA1, a wood-based, chemically activated, very high mesoporous content carbon, on the color and sulfur content of CTO was examined. Contact between the CA1 and any subsequent carbon and the CTO was for 1 day, as a slurry at 50° C. The results are summarized in Table 4. It was found that 20% CA1, or two treatments with CA1, gave better results than a 10% CA1 treatment followed with a 10% treatment with another powder activated carbon (PAC).

TABLE 4
Summary of Gardner Color and sulfur content changes
for CTO contacted with various amounts of AC.

| Initial | Color^{c} | Sulfur | Subsequent | Color^{c} | Sulfur |
|---|---|---|---|---|---|
| Treatment^{a} | (Gardner) | (ppm) | Treatment^{a} | (Gardner) | (ppm) |
| None | >18 | 979 | None | — | — |
| 20% CA1 ^{b} | 10.2 | 455 | None | — | — |
| 10% CA1 ^{b} | 11.9 | 557 | 10% CA1 ^{b} | 9.8 | 339 |
| 10% CA1 ^{b} | 11.9 | 557 | 10% Darco | 11.4 | 501 |
| | | | G-60^{d} | | |
| 10% CA1 ^{b} | 11.9 | 557 | 10% PAC | 11.7 | 495 |
| | | | 200^{e} | | |
| 10% CA1 ^{b} | 11.9 | 557 | 10% Darco | 11.2 | 549 |
| | | | S-51 ^{f} | | |

^{a}Percentages of are for the overall slurry (e.g., “20% CA1” means the slurry contained 20% CA1).
^{b} CA1 is a wood based powdered chemically activated carbon.
^{c}Gardner color testing was for neat samples.
^{d}Darco G-60 is a powdered steam activated carbon.
^{e}PAC 200 is a bituminous coal based PAC.
^{f} Darco S-51 is a lignite based powdered steam activated carbon.

### Example 3

Discussed herein are experiments that examined means of removing color impurities and sulfur levels in tall oil fatty acid, crude fatty acid, crude tall oil, and rosin. Also, the chemical properties and structures of the impurities were examined; these properties can aid in the ability to assess the industry implications of these experiments.

A total of fourteen activated carbons were evaluated for feasibility and effectiveness in removing color impurities from tall oil fatty acids (TOFA), crude fatty acids (CFA), and crude tall oil (CTO). F1 clay was used as a benchmark in all initial experiments performed. A summary of the properties of the activated carbons and the F1 day is shown in Table 5.

TABLE 5
Summary of the properties of the activated carbons.

| | Raw | | | | Pore structure | | | Surf. | |
|---|---|---|---|---|---|---|---|---|---|
| | Mater. | Activ. | Appear. | Wash | Micro | Meso | Macro | Area | pH |
| Darco G-60 | — | Steam | Powder | | | | | | |
| Exp 607 | — | — | Granular | | | | | | |
| PAC 200 | Bitum. coal | — | Powder | | | | | | |
| Calgon 12 × 40 | Bitum. coal | Steam | Granular | | High | Low | Med. | | |
| GAC 300 | Bitum. coal | Steam | Granular | | High | Low | Med. | | |
| Exp 631 | Wood | Chem. | Powder | H₃PO₄ | High | Very high | High | | |
| ROX 0.8 | Peat | Steam | Extruded | Acid | High | Med. | High | 1225 | Neutral |
| Darco S-51^{a} | Lignite | steam | Powder | | Med. | High | High | 650 | 4.3-7.0 |
| Darco 12 × 20^{a} | Lignite | Steam | Granular | Acid | Med. | High | High | 650 | 1.5 |
| Darco KB-M^{b} | Wood | Chem. | Powder | H₃PO₄ | High | Very high | High | | 2.0-4.0 |
| Darco KB-G^{b} | Wood | Chem. | Powder | H₃PO₄ | High | Very high | High | 1700 | 2.0-3.5 |
| CA3^{b} | Wood | Chem. | Powder | H₃PO₄ | High | Very high | High | 1000 | 2.0-3.5 |
| Norit CA1^{c} | Wood | Chem. | Powder | H₃PO₄ | High | Very high | High | 1400 | 2.0-3.5 |
| Norit C-gran^{d} | Wood | Chem. | Granular | H₃PO₄ | High | Very high | High | 1400 | 2.0-8.0 |
| F1 clay^{e} | Clay | Chem. | Powder | H₂SO₄ | High | Very high | High | | Acidic |

Abbreviations:
Raw Mater. = Raw Material;
Bitum. coal = Bituminous coal;
Activ. = Activation Method;
Appear. = Appearance;
Med. = Medium;
Surf. Area = Surface Area
^{a}Increases sulfur
^{b}As effective as CA1
^{c}Most effective powder; easily filtered
^{d}Most effective granular; easily filtered
^{e}Control; highly effective; easily filtered

Chemically activated and steam activated adsorbents were tested for adsorption with a TOFA Sylfat FA2 feedstock (FA2). FA2 samples were individually treated with 10% of CA1, Calgon 12x40, exp 607, F1 clay, or Darco G-60, and run at room temperature and 50° C. under agitation. An aliquot (˜8 ml) of each sample was taken at 15 min, 1 hour (hr), 2 hr, and overnight, centrifuged, filtered through 0.45 μm Whatman syringe filters, and measured for color using both the Gardner and APHA scales. A control TOFA sample was run under the same conditions and measured for color at the same time intervals. The results are summarized in Table 6 for the room temperature experiments. C-Gran and CA1 carbon showed the most reduction in color of FA2 from the original measurement of 4.5 on the Gardner scale. Higher percent treatments showed higher color reduction over the time indicated. Increased temperature (e.g., 50° C.) showed no significant effect on color reduction.

TABLE 6
Summary of Gardner color data for FA2 samples
treated with various adsorbents.

| | | Gardner Color after exposure time | | | | |
|---|---|---|---|---|---|---|
| | | | | | | Δ |
| Conditions | | | | | | (initial − |
| Additive | Dosage | Initial | 15 min. | 2 hrs. | Overnight | overnight) |
| None (control) | 0 | 4.5 | 4.3 | 4.3 | 4.4 | 0.1 |
| F1 clay | 5 | 4.5 | 2.2 | 1.2 | 1.8 | 2.7 |
| Exp 607 | 10 | 4.5 | 3.1 | 2.1 | 2.0 | 2.5 |
| Darco 60 | 10 | 4.5 | 2.6 | 2.5 | 2.2 | 2.3 |
| ROX 0.8 | 5 | 4.5 | 3.7 | 2.9 | 2.6 | 1.9 |
| GAC 300 | 5 | 4.5 | 3.8 | 3.5 | 2.6 | 1.9 |
| PAC 200 | 5 | 4.5 | 2.4 | 2.5 | 2.3 | 2.2 |
| Calgon 12 × 40 | 10 | 4.5 | 3.7 | 2.6 | 2.2 | 2.3 |
| Norit S-51 | 10 | 4.5 | 2.1 | 2.2 | 2.2 | 2.3 |
| Darco 12 × 20 | 10 | 4.5 | 3.0 | 2.0 | 2.9 | 1.6 |
| Norit Exp 631 | 5 | 4.5 | 1.7 | 1.8 | 2.3 | 2.2 |
| Norit CA3 | 5 | 4.5 | 1.8 | 1.8 | 2.1 | 2.4 |
| Darco KB-G | 5 | 4.5 | 1.5 | 1.6 | 2.0 | 2.5 |
| Darco KB-M | 5 | 4.5 | 1.8 | 2.0 | 2.1 | 2.4 |
| CA1 | 5 | 4.5 | 1.9 | 1.8 | 1.9 | 2.6 |
| C-Gran | 5 | 4.5 | 3.7 | 2.8 | 1.9 | 2.6 |

Two lignite based carbons were also tested for color reduction ability in FA2 TOFA. Norit S-51 and Darco 12x20 were added to FA2 at 10% treatment dosages and run at room temperature under constant agitation. Color samples were taken at 15 min, 1 hr, 2 hr, and overnight, filtered using 0.45 μm Whatman syringe filters, and measured for color using both the Gardner and APHA scales. The Gardner color results are summarized in Table 6. Norit S-51 showed a decrease in color initially but did not benefit from extended contact time with the FA2. Also, there was an increase in sulfur count from the original FA2. After toluene-washing the carbon by itself and testing the wash for sulfur count, it was determined that the increased sulfur was a result of the lignite based carbon. Darco 12x20 was also examined to help determine the origin of the increase in sulfur. Both Norit S-51 and Darco 12x20 carbons are lignite based and steam activated, but Darco 12x20 is granular and acid washed, Darco 12x20 also decreased the color of the FA2. After running the sulfur counts on a toluene washed sample of Darco 12x20, it was determined that the lignite raw material was responsible for the increase in sulfur for these samples.

Four other wood based carbons, two bituminous coal, and one peat carbon were also tested for color reduction ability. Darco KB-M, Darco KB-G, Norit CA3, Norit exp 631, GAC 300, PAC 200, and ROX 0.8 were added to TOFA at 5% treatment dosages and run at room temperature under constant agitation. Color samples were taken at 15 min, 2 hr, and overnight, filtered using 0.45 μm Whatman syringe filters, and measured for color using both the Gardner and APHA scales. The Norit exp 631 carbon was also tested at 1.5% dosage under the same conditions. Darco KB-M, Darco KB-G, Norit CA3, Norit exp 631 also showed similar color reduction as the original CA1 study. The color values are consistent with the F1 clay benchmark.

Lower percent treatments of FA2 were also tested. F1 clay treated. TOFA was run at both room temperature and 50° C. at 5%, 2%, 0.5%, and 0.1% under agitation. CA1 treated FA2 was run at room temperature at 5%, 2%, 0.5%, and 0.1% under agitation. C-Gran treated FA2 was run at room temperature at 10%, 5%, 2%, 0.5%, and 0.1% under agitation. Samples taken at 15 min, 1 hr, 2 hr, and overnight were centrifuged, filtered through 0.45 μm Whatman. syringe filters, and measured for color using both the Gardner and APHA scales. The Gardner color results for room temperature F1 clay experiments are summarized in Table 7. The Gardner color results for the FA2 samples treated with --Gran are summarized in Table 8. The Gardner color results for the room temperature CA1 experiments are summarized in Table 9. Higher percent treatments showed higher color reduction over the time indicated.

TABLE 7
Gardner color data for FA2 samples treated
with F1 clay at room temperature.

| Conditions | | | | | |
|---|---|---|---|---|---|
| | Dosage | Gardner Color after exposure time | | | |
| Additive | (wt %) | Initial | 15 min. | 1 hour | Overnight |
| None (Control) | 0.0 | 4.5 | 4.3 | 4.3 | 4.4 |
| F1 Clay | 0.1 | 4.5 | 4.2 | 4.2 | 4.0 |
| F1 Clay | 0.5 | 4.5 | 3.9 | 3.8 | 3.3 |
| F1 Clay | 2.0 | 4.5 | 2.8 | 2.2 | 2.6 |
| F1 Clay | 5.0 | 4.5 | 2.2 | 1.2 | 1.8 |

TABLE 8
Gardner color data for FA2 samples treated
with C-Gran at room temperature.

| Conditions | | | | | | |
|---|---|---|---|---|---|---|
| | Dosage | Gardner Color after exposure time | | | | |
| Additive | (wt %) | Initial | 15 min. | 1 hour | 2 hours | Overnight |
| None (Control) | 0.0 | 4.5 | 4.3 | 4.3 | 4.3 | 4.4 |
| C-Gran | 0.1 | 4.5 | 4.2 | 3.1 | 4.2 | 4.2 |
| C-Gran | 0.5 | 4.5 | 4.1 | 3.7 | 4.0 | 3.6 |
| C-Gran | 2.0 | 4.5 | 3.9 | 4.0 | 3.5 | 2.9 |
| C-Gran | 5.0 | 4.5 | 3.7 | 4.3 | 2.8 | 1.9 |

TABLE 9
Gardner color data for FA2 samples treated
with various amounts of CA1.

| Conditions | | | | | | |
|---|---|---|---|---|---|---|
| | Dosage | Gardner Color after exposure time | | | | |
| Additive | (wt %) | Initial | 15 min. | 1 hour | 2 hours | Overnight |
| CA1 | 10% | 4.5 | 1.6 | 1.3 | 1.3 | 1.3 |
| CA1 | 5% | 4.5 | 1.9 | 1.7 | 1.8 | 1.9 |
| CA1 | 2% | 4.5 | 2.6 | 2.3 | 2.3 | 2.4 |
| CA1 | 0.5% | 4.5 | 3.7 | 3.6 | 3.6 | 3.6 |
| CA1 | 0.1% | 4.5 | 4.0 | 4.1 | 4.1 | 4.0 |

CA1 and F1 clay were both tested for 5% and 2% treatments of FA2 while under vacuum. Samples were run at room temperature under constant vacuum and under agitation. Samples taken at 15 min, 1 hr, 2 hr, and overnight were centrifuged, filtered through 0.45 μm Whatman syringe filters, and measured for color using both the Gardner and APHA scales. The Gardner color results for the vacuum experiments are summarized in Table 10. Vacuum showed no increase in color reduction.

TABLE 10
Effect of vacuum on Gardner color data for FA2
samples treated with various adsorbents.

| Conditions | | | | | | |
|---|---|---|---|---|---|---|
| | Dosage | | Gardner Color after exposure time | | | |
| Additive | (wt %) | Vacuum | Initial | 15 min. | 1 hour | Overnight |
| None (control) | 0 | No | 4.5 | 4.3 | 4.3 | 4.3 |
| CA-1 | 2 | No | 4.5 | 2.6 | 2.3 | 2.4 |
| CA-1 | 5 | No | 4.5 | 1.9 | 1.7 | 1.9 |
| CA-1 | 2 | Yes | 4.5 | 2.3 | 2.5 | 2.5 |
| CA-1 | 5 | Yes | 4.5 | 1.6 | 1.4 | 1.7 |
| F1 Clay | 2 | No | 4.5 | 2.8 | 2.2 | 2.6 |
| F1 Clay | 5 | No | 4.5 | 2.2 | 1.7 | 1.8 |
| F1 Clay | 2 | Yes | 4.5 | 2.5 | 2.6 | 3.1 |
| F1 Clay | 5 | Yes | 4.5 | 2.5 | 1.6 | 1.6 |

Blended treatments of FA2 were also tested. FA2 was treated with 5% CA1, run under agitation, completely filtered using size 4 Whatman filter cups and filter aid, and then treated with additional 5% F1 clay. Color samples were taken at 1 hr and 2 hr prior to the second treatment, and at 1 hr, 2 hr, and overnight of the blended treatments. The opposite blend was also tested with the addition of 5% F1 clay and then an additional 5% CM treatment afterwards, The same samples were taken. FA2 was also treated with 5% CA1 and 5% F1 clay simultaneously and sampled for color at 1 hr, 2 hr, and overnight. The same blend was run with 2.5% CA1 and 2.5% F1 clay together and then sampled for color at 1 hr, 2 hr, and overnight. The Gardner color results for the 5% blended experiments are summarized in Table 11. The blended treatments did not show any substantial difference in color reduction when compared to same percent pure treatments. This suggests that the color bodies being removed by each treatment individually are mostly the same.

TABLE 11
Gardner color data for blended treatments of FA2.

| | Gardner Color | | | | Gardner Color | | |
|---|---|---|---|---|---|---|---|
| Initial | after exposure time | | | Subsequent | after exposure time | | |
| treatment | 1 hr | 2 hrs | ON* | treatment | 1 hr | 2 hrs | ON* |
| 5% CA1 | 1.6 | 1.4 | 1.5 | 5% F1 Clay | 0.8 | 0.6 | 0.8 |
| 5% F1 Clay | 2.1 | 1.6 | 1.4 | 5% CA1 | 0.9 | 0.9 | 1.1 |
| 5% F1 Clay, | 1.1 | 0.9 | 0.8 | None | — | — | — |
| 5% CA1 | | | | | | | |

*ON = overnight

Since the chemically activated carbons can have residual acid levels left over from the activation process, the contribution of acids to the overall ability of the carbon to adsorb impurities was tested. TOFA treated with various acids and carbon was tested. FA2 samples were treated individually with 1% neat sulfuric acid, acetic acid, and phosphoric acid. Color samples were taken at 15 minutes. Each acid/FA2 sample was divided into three flasks and additionally treated with 3% of F1 clay, CA1, or Darco 60. Color samples were taken at 2 hrs. Three more FA2 samples were then run using 1% neat sulfuric acid, acetic acid, and phosphoric acid. Color samples were taken at 15 minutes. 10% CA1 was then added to each one and color samples were taken at 2 hrs. Acidifying FA2 allowed for the determination that acid does not further activate the carbon or clay treatments. CA1 is chemically activated with a phosphoric acid wash and while F1 clay is activated by a sulfuric acid wash, but additional acid showed no improvements on color reduction. Chemical activation of the adsorbents prior to use has an increased effect of the removal of color, but adjustments to the pH afterwards showed no substantial changes. Therefore, the acid contribution can be important during the activation process, but any residual acid showed no increase in the adsorption properties of the carbon.

Active versus passive conditions were also evaluated. C-gran, a granular carbon, was used to test for color removal under simulated shipping conditions. Treatments of 10% and 3% were added to FA2 and left to sit overnight at room temperature with minimal agitation in the form of manual swirling three times. One sample was taken from each dosage, filtered using 0.45 μm Whatman syringe filters, and measured for color using both the Gardner and APHA scales. Without agitation, the C-gran samples showed a decrease in color similar to results with agitation. A powdered carbon was not tested because of the difficultly in filtering and removing a powder from large volumes of feed. Residual powdered carbon is highly likely, whereas a granular carbon will settle naturally and be easily able to separate from the feedstock.

The three most effective treatments from the previous studies, (CA1, F1 clay, C-gran), were tested for effectiveness when coupled with cavitation at room temperature. Samples were run at 10% treatment of FA2 for 15 minutes under sonication. One color sample was taken immediately after sonication, filtered using 0.45 μm Whatman syringe filters, and measured for color. The remaining FA2 treatments were run under agitation. Color samples were taken at 2 hrs and overnight, filtered using 0.45 μm Whatman syringe filters, and measured for color using both the Gardner and APHA scales. The Gardner color results for the cavitation experiments are summarized in Table 12. The FA2 samples run with cavitation did not show any increase in effectiveness of color removal. In fact, less reduction of impurities (e.g., less color change) was observed than with previous samples that were not placed under cavitation. Since cavitation can be expensive on a plant scale, this result can be beneficial for scaled up experiments.

TABLE 12
Effect of cavitation on Gardner color data for
FA2 samples treated with various adsorbents.

| | |
|---|---|
| Conditions | Gardner Color after exposure |

| Additive | Method | 15 minutes | 2 hours | Overnight |
|---|---|---|---|---|
| CA1 | cavitation | 1.9 | 1.5 | 1.3 |
| C-Gran | cavitation | 3.8 | 3.3 | 1.3 |
| F1 Clay | cavitation | 2.8 | 2.5 | 2.7 |

The three most effective treatments from the FA2 studies (5% CA1, 5% C-Gran, and 5% F1 Clay) were chosen to test against other feedstocks. Sylfat 2LT, Sylfat 2, Sylfat FA1, and Oulu CFA feedstocks were all individually treated with 5% of CA1, C-Gran, and F1 Clay, and run at room temperature under agitation. Approximately 8 ml of sample was taken at 15 min, 2 hr, and overnight, centrifuged, filtered through 0.45 μm Whatman syringe filters, and measured for color using both the Gardner and APHA scales. A control sample for each feedstock was also run under the same conditions and measured for color at the same time intervals.

The Gardner color results are summarized in Table 13, where the FA2 data from Table 6 has been reproduced for convenience. Changes in Gardner color values with each different treatment show the relative effectiveness of each treatment against each different feed stock. Since impurities are different between the various feedstocks, discrepancies in the nominal values for Gardner color are expected. Still, similar results in color reduction (e.g., the difference in the Gardner color from the initial measurement to the overnight measurement) were observed across all feedstocks. The results show that the more impure the raw feed, the greater the overall color reduction regardless of treatment type. This shows that most impurities are in the meso range in all stages of the distillation process. Also, the meso impurities seem to be the first to be removed in the distillation process before smaller and/or larger impurities.

TABLE 13
Gardner color data for various feedstocks
treated with CA1, F1 Clay or C-Gran.

| | | Gardner Color after exposure time | | | | |
|---|---|---|---|---|---|---|
| | | | | | | Δ |
| | | | | | | (initial − |
| Feedstock | Treatment | Initial | 15 min. | 2 hrs. | Overnight | overnight) |
| Sylfat | none | 4.5 | 4.3 | 4.3 | 4.4 | 0.1 |
| FA2 | 5% CA1 | 4.5 | 1.9 | 1.8 | 1.9 | 2.6 |
| | 5% F1 Clay | 4.5 | 2.2 | 1.2 | 1.8 | 2.7 |
| | 5% C-Gran | 4.5 | 3.7 | 2.8 | 1.9 | 2.6 |
| Sylfat | none | 4.1 | 3.9 | 3.9 | 3.8 | 0.3 |
| 2LT | 5% CA1 | 4.1 | 1.1 | 0.8 | 0.9 | 3.2 |
| | 5% F1 Clay | 4.1 | 1.7 | 1.1 | 1.1 | 3.0 |
| | 5% C-Gran | 4.1 | 2.7 | 1.8 | 1.1 | 3.0 |
| Sylfat | none | 4.1 | 4.0 | 4.0 | 3.9 | 0.2 |
| 2 | 5% CA1 | 4.1 | 1.3 | 0.8 | 0.8 | 3.3 |
| | 5% F1 clay | 4.1 | 1.6 | 1.2 | 1.3 | 2.8 |
| | 5% C-Gran | 4.1 | 3.1 | 2.1 | 1.4 | 2.7 |
| Sylfat | none | 5.7 | 5.7 | 5.7 | 5.8 | −0.1 |
| FA1 | 5% CA1 | 5.7 | 2.1 | 1.9 | 2.1 | 3.6 |
| | 5% F1 clay | 5.7 | 2.9 | 1.2 | 1.0 | 4.7 |
| | 5% C-Gran | 5.7 | 4.8 | 4.0 | 2.8 | 2.9 |
| Oulu | none | 9.7 | 9.7 | 9.7 | 9.6 | 0.1 |
| CFA | 5% CA1 | 9.7 | 6.3 | 6.1 | 5.9 | 3.8 |
| | 5% F1 clay | 9.7 | 7.5 | 6.5 | 6.2 | 3.5 |
| | 5% C-Gran | 9.7 | 8.5 | 8.0 | 6.4 | 3.3 |

Chemically activated adsorbents were tested for adsorption with Oulu CTO. The CTO samples were individually treated with 5% of CA1, F1 Clay, and C-gran, and run at room temperature under high agitation. A CTO sample was also run with 10% CA1 under the same conditions. Only the three most effective treatments from the Sylfat FA2 experiments were used. Approximately 8 ml of sample was taken at 15 min, 2 hr, and overnight, centrifuged, filtered through a 0.45 μm Whatman syringe filter, and measured for color using both the Gardner and APHA scales. CTO samples had to be heated prior to filtration in order to make the process more efficient. Syringes used for filtration were also heated lightly. A control CTO sample was run under the same conditions and measured for color at the same time intervals.

The Gardner color results are summarized in Table 14. Gardner values were not able to give a quantitative indication of color reduction. Visually, a decrease in color was evaluated by the amount of light that was able to pass through the sample over increased contact time and with the higher percent treatment. The three treatments yielded similar color reductions as with the other feed stocks. Sulfur counts are also shown in Table 14, and they decreased over time.

TABLE 14
Gardner color data and sulfur counts from treated Oulu CTO.

| | Gardner Color after exposure time | | | | Sulfur |
|---|---|---|---|---|---|
| Sample | Initial | 15 min | 2 hr | Overnight | (ppm) |
| CTO | >18 | >18 | >18 | >18 | 1618.7 |
| 5% CA1 | >18 | >18 | >18 | >18 | 1442.8 |
| 5% F1 clay | >18 | >18 | >18 | >18 | 1632.6 |
| 5% C-Gran | >18 | >18 | >18 | >18 | 1641.9 |
| CA1 | >18 | >18 | >18 | 18.8 | 1368.7, 1468.8, |
| | | | | | 1270.4 |

Evaluating the sulfur reduction potentials of each carbon not only allows for another possible application for carbon adsorption, but can also help to narrow down the chemistry and structure of the impurities being removed. Sulfur analysis was performed on each feedstock for the three most effective treatments (5% of CA1, F1 clay and C-Gran) using an Antek single element analyzer. Approximately 1.0 g of each TOFA sample was brought up in toluene in a 5 ml volumetric flask. Approximately 0.3 g of the CTO and CFA samples was brought up in toluene in a 10 ml volumetric flask. The results are summarized in Table 15. The sulfur results show a similar trend as the color data. CA1, C-gran, and F1 clay showed a much greater reduction in sulfur count than the other treatments tested. Also, higher percent treatments show a greater reduction in sulfur count, CA1 and C-gran showed an increased sulfur reduction over F1 clay.

TABLE 15
Sulfur content (ppm) from 5% treatments of each feedstock.

| | Treatment | | | | |
|---|---|---|---|---|---|
| | None | 5% | 5% F1 | 5% | |
| Feedstock | (control) | CA1 | clay | C-Gran | Reproducibility |
| FA2 | 50.0 | 24.1 | 22.4 | 29.1 | ±7 |
| FA1 | 84.1 | 33.8 | 50.1 | 46.0 | ±12 |
| Sylfat 2 | 46.6 | 19.0 | 29.1 | 24.7 | ±6 |
| Sylfat 2LT | 44.2 | 19.0 | 27.6 | 24.3 | ±6 |
| CFA | 290.4 | 158.5 | 180.3 | 168.6 | ±43 |
| CTO | 1618.7 | 1442.8 | 1632.6 | 1641.9 | ±242 |

All samples taken from each treatment of each feedstock were measured for color stability over the course of 4.5 weeks. Samples are maintained in glass color tubes with corked tops and run on the Gardner and APHA scales at least one time each week. The results of the color stability tests showed that the samples did not degrade post-filtration. This indicates a high stability of the samples over time. Also, the filtration process is effective and efficient at removing all the added treatment before color measurements are run.

Results from the C-Gran treated agitated versus un-agitated samples discussed above lead to further studies in which shipping and storage conditions were simulated. Norit C-Gran was used in enclosed tea infusers to treat various fatty acid feedstocks over an extended period of time. The C-Gran was pre-washed with IPA to remove fines and dried overnight. The carbon was heated for 5-8 minutes at 80° C. just before use. In order to prevent carbon from leaking, only infusers that locked tightly were used. Each infuser was loaded with washed carbon and lowered into the sample, ensuring complete submersion of the infuser. Sylfat FA1, Sylfat FA2, and Oulu CFA were treated with 5% C-gran each. A control sample with FA2 and an empty tea infuser was also run. Color samples were taken at 15 min, 4 hr, 8 hr, overnight and daily for 14 days total. Samples were measured on both the Gardner and APHA scales and immediately returned to their sample beakers.

The Gardner color results are summarized in Table 16. Significant reduction in color with the tea infusers is observed. The color reduction was gradual, but eventually similar Gardner values were seen as without enclosed carbon.

TABLE 16
Gardner color values taken over 14 days
with carbon enclosed in tea infusers.

| | | | FA1 | CFA | FA2 | FA2 |
|---|---|---|---|---|---|---|
| | Raw material | | 5% C- | 5% | 5% | None |
| | Treatment | | Gran | C-Gran | C-Gran | (Control) |
| Gardner | Initial | | 5.7 | 9.7 | 4.5 | 4.5 |
| Color | 15 | min. | 5.9 | 9.7 | 4.2 | 4.2 |
| after | 4 | hr. | 5.5 | 9.5 | 3.8 | 4.1 |
| Exposure | 8 | hr. | 4.9 | 8.3 | 3.5 | 4.0 |
| time | 1 | day | 4.5 | 8.2 | 2.8 | 4.3 |
| | 2 | days | — | — | 2.4 | 4.3 |
| | 3 | days | 4.2 | 8.1 | — | — |
| | 4 | days | 3.8 | 8.0 | 2.2 | 4.1 |
| | 5 | days | 3.7 | 7.8 | 1.8 | 3.9 |
| | 6 | days | 3.6 | 7.5 | 1.7 | 3.8 |
| | 10 | days | 3.7 | 7.3 | 2.2 | — |
| | 11 | days | 3.7 | 7.2 | 1.6 | 3.8 |
| | 12 | days | 3.8 | 7.1 | 1.5 | 3.7 |
| | 13 | days | 3.0 | 7.1 | 1.1 | — |
| | 14 | days | 3.5 | 7.2 | 1.7 | — |

Analytical data was used to show that no changes to the basic chemical properties were altered from treatment with activated carbon. GC and HTGC results are shown below in Tables 17-20. The results show that the major isomers in the TOFA samples remain the same before and after treatment and that only the color bodies are removed by the adsorbents.

TABLE 17
GC results from a first tea infuser experiment.

| | Feedstock | | | | | |
|---|---|---|---|---|---|---|
| | FA1 | | FA2 | | CFA | |
| Treatment | None | 5% C-gran | None | 5% C-gran | None | 5% C-gran |
| Palmitic (C16) fatty acid | 1.2 | 1.3 | 1.1 | 1.2 | 2.4 | 2.5 |
| Stearic (C18) Acid | 2.1 | 2.2 | 2.1 | 2.1 | 1.3 | 1.3 |
| Eicosanoic (C20) acid | 0.4 | 0.5 | 0.1 | 0.2 | 0.9 | 0.8 |
| C17:0 fatty acid | 0.2 | 0.2 | 0.3 | 0.3 | 0.2 | 0.2 |
| C17:0 Fatty acid isomer | 0.6 | 0.6 | 0.9 | 0.9 | 0.6 | 0.6 |
| C19:0 fatty acid | 0.4 | 0.5 | 0.3 | 0.3 | 0.3 | 0.3 |
| Eladic (C18:1) acid | 1.1 | 1.2 | 1.5 | 1.5 | 0.6 | 0.5 |
| Oleic (C18:1) acid | 40.6 | 40.8 | 57.8 | 48.3 | 22.0 | 21.6 |
| Eicosenoic (C20:1) acid | 1.3 | 2.3 | 1.0 | 0.8 | 1.8 | 1.6 |
| C18:1 fatty acid | 0.7 | 0.8 | 0.8 | 0.8 | 0.7 | 0.7 |
| Linoleic (C18:2) acid | 30.1 | 29.7 | 33.7 | 33.7 | 32.9 | 33.1 |
| Conj. Linoleic (C18:2) acids | 3.6 | 4.0 | 1.8 | 1.6 | 6.6 | 3.5 |
| Eicosadienoic (C20:2) acid | 0.8 | 0.9 | 0.1 | 0.2 | 1.2 | 1.1 |
| C18:2 acid isomers | 2.1 | 2.7 | 2.0 | 2.0 | 1.5 | 1.5 |
| Pinolenic (C18:3) acid | 1.8 | 1.9 | 2.3 | 2.3 | 5.4 | 5.5 |
| Eicosatrienoic (C20:3) acid | 2.9 | 2.9 | 0.3 | 0.3 | 2.6 | 2.6 |
| C18:3 fatty acid | 4.1 | 4.2 | 1.0 | 1.0 | 0.9 | 3.5 |
| C18:3 fatty acid isomers | 0.7 | 0.6 | 0.1 | 0.1 | 0.9 | 0.8 |
| Low Boiling Fatty acids | — | — | — | 0.0 | 0.4 | 0.3 |
| Fatty Acid Isomers 1 | 0.3 | 0.3 | 0.2 | 0.2 | 0.8 | 0.7 |
| Fatty Acid Isomers 2 | 1.6 | 1.1 | 0.9 | 0.9 | 1.4 | 1.5 |
| Fatty Acid Isomers 3 | 0.4 | 0.4 | 0.2 | 0.1 | 0.5 | 0.5 |
| Fatty Acid Isomers 4 | 0.7 | 0.8 | 0.3 | 0.3 | 0.6 | 0.6 |
| Rosin acid isomers/neutrals | 3.6 | 3.1 | 2.3 | 1.9 | 16.3 | 15.1 |
| Total wt % by GC | 101.1 | 102.5 | 101.0 | 100.8 | 102.5 | 100.4 |

TABLE 18
GC results from a second tea infuser experiment.

| | FA1, 5% | CFA, 5% | FA2, 5% | FA2 |
|---|---|---|---|---|
| Component | C-Gran | C-Gran | C-gran | (Control) |
| Palmitic (C16) fatty acid | 1.2 | 2.5 | 1.1 | 1.1 |
| Stearic (C18) Acid | 2.1 | 1.2 | 2.0 | 2.0 |
| Eicosanoic (C20) acid | 0.3 | 0.7 | 0.0 | 0.0 |
| C17:0 fatty acid | 0.6 | 0.6 | 0.8 | 0.8 |
| C17:0 Fatty acid isomer | 0.2 | 0.2 | 0.3 | 0.2 |
| C19:0 fatty acid | 0.3 | 0.3 | 0.2 | 0.2 |
| Eladic (C18:1) acid | 1.1 | 0.4 | 1.4 | 1.4 |
| Oleic (C18:1) acid | 41.1 | 21.2 | 48.0 | 47.7 |
| Eicosenoic (C20:1) acid | 1.8 | 1.6 | 0.0 | 0.0 |
| C18:1 fatty acid | 0.7 | 0.6 | 0.8 | 0.7 |
| Linoleic (C18:2) acid | 29.4 | 32.5 | 32.3 | 32.8 |
| Conj. Linoleic (C18:2) | 6.9 | 6.8 | 3.2 | 2.6 |
| acids | | | | |
| Eicosadienoic (C20:2) | 0.7 | 1.1 | 0.0 | 0.0 |
| acid | | | | |
| C18:2 acid isomers | 2.6 | 1.7 | 2.2 | 2.2 |
| Pinolenic (C18:3) acid | 1.7 | 5.4 | 2.2 | 2.2 |
| Eicosatrienoic (C20:3) | 2.9 | 2.5 | 0.2 | 0.2 |
| acid | | | | |
| C18:3 fatty acid | 0.0 | 0.0 | 0.0 | 0.0 |
| C18:3 fatty acid isomers | 0.0 | 0.0 | 0.0 | 0.0 |
| Low Boiling Fatty acids | 0.0 | 0.2 | 0.0 | 0.0 |
| Fatty Acid Isomers 1 | 0.0 | 0.4 | 0.2 | 0.1 |
| Fatty Acid Isomers 2 | 0.7 | 1.1 | 0.4 | 0.5 |
| Fatty Acid Isomers 3 | 0.7 | 1.2 | 0.0 | 0.0 |
| Fatty Acid Isomers 4 | 0.0 | 0.0 | 0.0 | 0.0 |
| Rosin acid isomers/ | 3.2 | 14.5 | 1.5 | 1.8 |
| neutrals | | | | |
| Total wt % by GC | 98.4 | 96.8 | 96.7 | 96.6 |

TABLE 19
HTGC results from a first tea infuser experiment.

| | Feedstock | | | | | |
|---|---|---|---|---|---|---|
| | FA1 | | FA2 | | CFA | |
| Treatment | None | 5% C-gran | None | 5% C-gran | None | 5% C-gran |
| FA & or Rosin Monomer | 99.4 | 99.5 | 99.1 | 98.7 | 99.7 | 99.5 |
| Thermal Dimer | 0.59 | 0.50 | 0.87 | 1.28 | 0.33 | 0.47 |
| Total | 100.0 | 100.0 | 100.0 | 100.0 | 100.0 | 100.0 |

TABLE 20
HTGC results a second tea infuser experiment.

| | FA1, 5% | CFA, 5% | FA2, 5% | FA2 |
|---|---|---|---|---|
| | C-Gran | C-Gran | C-gran | (Control) |
| FA & or Rosin Monomer | 99.35 | 99.42 | 98.80 | 98.52 |
| Thermal Dimer | 0.65 | 0.58 | 1.20 | 1.48 |
| Total | 100.00 | 100.00 | 100.00 | 100.00 |

The tea infuser technique was also tested on NCY and HYR rosin. Norit C-Gran was pre-washed with IPA to remove fines and dried overnight. The carbon was heated for 5-8 minutes at 80° C. just before use. In order to prevent carbon from leaking, only infusers that locked tightly were used. Rosin was heated using a sand bath on a hot plate. Once rosin was molten, tea infusers were lowered into the rosin and completely submerged. Hot plates were set at 370-390° C. for NCY and 390-410° C. for HYR. HYR samples were treated at 0.2%, 0.8%, and 1.5%. NCY samples were treated at 0.2% and 1.5%. Control HYR and NCY samples were also run. Color samples were collected at 15 min, overnight and daily for up to six days total. Each sample was run on both Gardner and APHA scales and then immediately returned to the sample beaker. The Gardner color results of the NCY and HYR initial tea infuser study are summarized in Table 21, and were consistent with the C-Gran data from previous experiments with various feeds. An increase in color overall was observed, but a difference of approximately 2 Gardner was seen between the treated and untreated samples of both the NCY and HYR experiments.

TABLE 21
Gardner color values of rosin samples after treatment with C-Gran.

| | Conditions | | Gardner color after exposure | |
|---|---|---|---|---|
| | Temperature | Dosage | 15 | |
| Sample | (° C.) | (wt %) | minutes | 1 day |
| HYR rosin | 390-415 | 0 | 6.3 | 8.6 |
| HYR rosin | 390-415 | 0.2 | 7.2 | 13.8 |
| HYR rosin | 390-415 | 1.5 | 7.5 | 9.3 |
| NCY rosin | 390-415 | 0 | 8.4 | 15.8 |
| NCY rosin | 390-415 | 0.2 | 8.8 | 15.2 |
| NCY rosin | 390-415 | 1.5 | 9.4 | 12.0 |

A scaled up version of the HYR experiment was also performed. Approximately 1300 g of HYR was charged to two 2 L open top flasks. One flask was treated with 1.2% C-gran in tea infusers and the other was run as a control. The tea infusers were loaded prior to heating the rosin so the top of the flask could be sealed and not broken later on. The HYR was run under constant nitrogen purge and ramped to an internal temperature of 150-165° C. Once molten, color samples were taken at 2 hrs, overnight and daily for 14 days total. Samples were run on the Gardner scale only and then immediately returned to the flask. A heat gun was used to try to melt some of the crystallization back down into the flask after color samples were taken for the day.

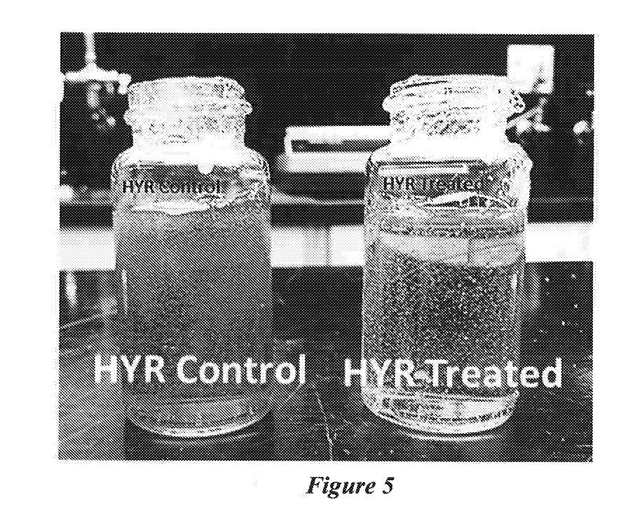

The Gardner color results the scaled up HYR experiment are summarized in Table 22, and are consistent with C-Gran data from previous experiments with other feeds. An increase in color is observed over time, but a difference of approximately 2.8 Gardner is seen between the treated HYR and the control. The difference in color between the untreated HYR control sample and the 1.2% C-Gran treated HYR sample after 14 days is further shown in FIG. 5.

TABLE 22
Gardner color values from scaled up HYR rosin experiment.

| | | | HYR | 1.2% treated |
|---|---|---|---|---|
| | Sample | | (Control) | HYR |
| Gardner | 2 | hr. | 6.4 | 6.2 |
| Color | 3 | days | 6.8 | 6.7 |
| after | 4 | days | 9.4 | 7.2 |
| Exposure | 5 | days | 9.5 | 7.6 |
| time | 6 | days | 9.9 | 7.9 |
| | 7 | days | 10.1 | 8.0 |
| | 10 | days | 10.8 | 8.2 |
| | 11 | days | 11.2 | 8.3 |
| | 12 | days | 11.2 | 8.2 |
| | 13 | days | 11.0 | 8.2 |
| | 14 | days | 10.9 | 8.2 |

Analytical data was used to show that no changes to the basic chemical properties were altered from treatment with activated carbon. GC and HTGC results are shown below in Table 23 and Table 249, respectively. The results did not show any changes in the major isomer distribution.

TABLE 23
GC results from the scaled up HYR tea infuser experiment.

| | HYR, 1.2% | HYR |
|---|---|---|
| Component | C-gran | (control) |
| FA, Neutrals, Rosin | 2.7 | 2.5 |
| Rosin acid isomers/neutrals | 0.3 | 0.3 |
| Rosin acid isomers 1 | 2.3 | 2.1 |
| Rosin acid isomers 2 | 0.2 | 0.1 |
| 8,15 isopimaric acid | 4.0 | 2.4 |
| Pimaric acid | 1.4 | 2.5 |
| 8,15 pimaric acid | 3.8 | 2.7 |
| Sandaracopimaric acid | 1.7 | 2.1 |
| Isopimatic acid | 3.0 | 4.1 |
| Monounsaturated rosin | 5.2 | 3.2 |
| Poly-unsaturated rosin acids | 1.3 | 1.5 |
| Palustric acid | 5.2 | 5.4 |
| Acietic acid | 32.5 | 35.0 |
| Neoabietic acid | 2.5 | 2.6 |
| 7,9,(11) abietic acid | 2.7 | 3.1 |
| 13 B 7,9,(11) abietic acid | 4.8 | 4.2 |
| Non-conjugated abietic acids | 2.1 | 1.9 |
| Deisopropyl-dehydroabietic acid | 0.0 | 0.0 |
| Dehydroabeitic acid | 22.4 | 20.1 |
| Secodehydroabietic acids | 0.3 | 0.2 |
| Total weight by GC | 98.4 | 96.0 |

TABLE 24
HTGC results the scaled up HYR and tea infuser experiment.

| | HYR, 1.2% | HYR |
|---|---|---|
| | C-gran | (control) |
| FA & or Rosin Monomer | 97.55 | 97.30 |
| Thermal Dimer | 2.45 | 2.70 |
| Total | 100.00 | 100.00 |

The tea infuser technique was further tested for its ability to remove haze from a hydrogenated rosin ester. Approximately 230 g of Hydro RE 2085 was treated with 1.5% pre-washed C-gran enclosed in multiple tea infusers. The sample was run with a triple vacuum nitrogen purge and then maintained with constant nitrogen for the duration of the experiment. The external temperature was ramped gradually over the course of 2 days until the rosin ester was molten. The final external temperature was set to 180° C. Samples were taken daily, checked for haziness, run for color, and immediately returned to the sample flask. The results showed no decrease in haze of the treated hydrogenated rosin ester. The color was found to be 5.7 Gardner even though visually the samples were much lighter. The color is a result of the haze present in the sample.

To further examine shipping and storage conditions, Norit C-Gran was used in enclosed tea bags to treat various fatty acid feedstocks over an extended period of time. The C-Gran was pre-washed with IPA to remove fines and dried overnight. The carbon was heated for 5-8 minutes at 80° C. just before use. Each tea bag was loaded with washed carbon and stapled closed to ensure no carbon could leak out. The tea bags were then added to the designated feed and completely submerged. Sylfat FA2 and Sylfat 2LT were each treated at 0.2%, 0.4%, 0.8%, 1.2%, 1.5% and 5% dosages. Sylfat FA1 and Oulu CFA were each treated at 0.2%, 0.8%, and 1.5% dosages. Sylfat 2 was treated at 0.2%, 0.8%, 1.5% and 5% dosages. A control sample with FA2 and an empty tea bag was also run. All samples were run at room temperature with no agitation. Samples were taken at 15 min, 4 hrs, overnight, and once daily for 12 days total. Each sample was measured for color on the Gardner and APHA scales and then returned to the sample beaker. Final samples were taken and kept for color stability tests over 4 weeks. Cloud point measurements were taken on neat FA2, 1.5% C-Gran treated FA2, neat FA1, and 1.5% C-Gran treated FA1.

The Gardner color results of the tea bag experiments are summarized in Table 25. The 5% treated feeds showed similar color reduction with the tea bags as the same samples showed when the carbon was not enclosed. Samples treated at 1.5% show a significant decrease in color as well. The color reduction is gradual over the 12 days, but final color values show color reduction even at the lowest treatment dosages. Cloud points taken from on the treated samples showed no difference than the control samples.

TABLE 25
Gardner Color values taken over 12 clays with carbon sealed in tea bags.

| | C-Gran | Gardner Color value after exposure time | | | | | | | | | | |
|---|---|---|---|---|---|---|---|---|---|---|---|---|
| Feed | Dosage | 15 | 4 | 1 | 2 | 4 | 5 | 6 | 7 | 8 | 11 | 12 |
| stock | (%) | min. | hr. | day | days | days | days | days | days | days | days | days |
| Sylfat | 0 | 4.2 | 4.1 | 4.0 | 4.3 | 4.1 | 3.9 | 3.8 | 3.5 | 3.8 | 3.8 | 3.7 |
| FA2 | 0.2 | 4.4 | 4.1 | 3.9 | 4.0 | 4.3 | 1.0 | 3.3 | 3.2 | 3.4 | 3.3 | 3.3 |
| | 0.4 | 4.5 | 4.2 | 4.0 | 4.3 | 4.0 | 3.6 | 3.4 | 3.0 | 3.5 | 3.2 | 3.1 |
| | 0.8 | 5.1 | 4.0 | 3.9 | 3.8 | 3.9 | 3.5 | 3.0 | 2.8 | 3.1 | 3.0 | 2.9 |
| | 1.2 | 4.9 | 4.0 | 3.8 | 3.7 | 3.9 | 3.2 | 2.7 | 2.3 | 2.9 | 2.7 | 2.7 |
| | 1.5 | 4.6 | 4.0 | 4.1 | 3.9 | 3.8 | 3.3 | 2.7 | 2.2 | 2.8 | 2.6 | 2.4 |
| | 5 | 4.1 | 4.2 | 3.6 | 3.2 | 2.8 | 2.3 | 1.9 | 1.4 | 2.1 | 1.8 | 1.7 |
| Sylfat | 0.2 | 6.2 | 6.0 | 5.9 | 5.8 | 5.7 | 5.6 | 5.5 | 5.4 | 5.5 | 5.4 | 5.4 |
| FA1 | 0.8 | 6.3 | 5.8 | 5.8 | 5.6 | 5.7 | 5.5 | 5.4 | 5.1 | 5.2 | 5.1 | 5.1 |
| | 1.5 | 6.5 | 6.0 | 5.5 | 5.7 | 5.4 | 5.1 | 4.9 | 4.6 | 4.8 | 4.6 | 4.5 |
| Sylfat | 0.2 | 4.8 | 3.8 | 3.8 | 3.4 | 3.7 | 3.2 | 3.0 | 2.4 | 2.8 | 2.6 | 2.5 |
| 2LT | 0.4 | 4.0 | 4.1 | 3.9 | 4.1 | 3.7 | 3.0 | 2.8 | 2.0 | 2.7 | 2.3 | 2.2 |
| | 0.8 | 4.8 | 3.7 | 4.1 | 3.8 | 3.3 | 3.2 | 2.3 | 1.8 | 2.3 | 2.1 | 2.0 |
| | 1.2 | 4.9 | 3.9 | 3.6 | 3.4 | 3.6 | 2.7 | 2.2 | 1.6 | 2.1 | 1.9 | 1.8 |
| | 1.5 | 4.0 | 3.8 | 3.6 | 3.1 | 3.0 | 2.3 | 2.1 | 1.4 | 1.9 | 1.7 | 1.5 |
| | 5 | 3.8 | 3.7 | 3.4 | 2.2 | 2.1 | 1.5 | 1.3 | 0.7 | 1.5 | 1.1 | 1.0 |
| Sylfat | 0.2 | 4.0 | 3.7 | 3.8 | 3.4 | 3.9 | 3.2 | 2.8 | 2.3 | 2.8 | 2.6 | 2.6 |
| 2 | 0.8 | 5.0 | 3.6 | 3.3 | 3.4 | 3.1 | 2.9 | 2.4 | 1.5 | 2.2 | 2.0 | 1.9 |
| | 1.5 | 3.7 | 3.7 | 3.2 | 2.9 | 2.9 | 2.3 | 3.1 | 1.5 | 2.1 | 1.7 | 1.7 |
| | 5 | 3.9 | 3.7 | 3.1 | 3.2 | 1.9 | 1.8 | 1.8 | 0.8 | 1.5 | 1.3 | 1.2 |
| Oulu | 0.2 | 10.1 | 9.6 | 9.5 | 9.4 | 9.3 | 9.4 | 9.1 | 9.0 | 9.1 | 9.1 | 9.0 |
| CFA | 0.8 | 9.9 | 9.6 | 9.3 | 9.1 | 9.0 | 8.9 | 8.8 | 8.8 | 8.8 | 8.7 | 8.7 |
| | 1.5 | 9.7 | 9.6 | 9.2 | 9.0 | 8.8 | 8.7 | 8.5 | 8.5 | 8.5 | 8.4 | 8.4 |

Norit CA3 and Darco KB-G were run with tea bags to test the effectiveness of powdered carbons with this method. Norit ROX 0.8 was also tested to evaluate the effectiveness of an extruded carbon when using the tea bag method. All samples were run with FA2 feed and treated with 1.5% carbon. Samples were taken at 15 min, 2 hr, overnight, and daily and then immediately returned to the sample beakers. Color was measured on the Gardner and APHA scales. All samples were run at room temperature with no agitation. The Gardner color results are summarized in Table 26.

TABLE 26
Gardner color of SYLFAT FA2 samples treated with various carbons.

| Conditions | | Gardner color after exposure | | | | | | | | |
|---|---|---|---|---|---|---|---|---|---|---|
| | Dosage | 15 | 2 | 1 | 4 | 5 | 7 | 8 | 11 | 12 |
| Addititve | (wt %) | min. | hours | day | days | days | days | days | days | days |
| CA3 | 1.5 | 4.0 | 4.0 | 3.9 | 3.8 | 3.5 | 3.3 | 3.3 | 3.9 | 2.7 |
| KB-G | 1.5 | 4.1 | 4.1 | 4.0 | 3.8 | 3.6 | 3.4 | 3.4 | 3.0 | 2.8 |
| ROX 0.8 | 1.5 | 4.0 | 3.9 | 3.9 | 3.8 | 3.3 | 3.0 | 2.9 | 2.7 | 2.4 |

Conclusions

Various carbons were tested for the ability to adsorb color impurities from TOFA, CFA, CTO, and rosin. Carbons were evaluated on the basis of various properties and conditions including their raw material base, type of activation, acid contribution, cavitation, regional differences, type of feed, color stability over time, kinetics, and sulfur reduction.

The results of the FA2 feedstock studies suggested that wood based, chemically activated carbons provided the most effective treatment for reducing color impurities. The most effective PAC was CA1 which is an easily filtered, chemically activated powder with very high mesopore content and high micropore and macropore content. CA3, Darco KB-M, Darco KB-G, and Norit exp 631 share the same characteristics and were just as effective as the CA1 treatments. Economically, this provides a multitude of options for future studies and implications of such studies in industry. The most effective GAC was found to be the Norit C-Gran which is also chemically activated, easily filtered, and has a very high mesopore structure, high micropore, and high macropore structure.

Pore structure can affect the adsorption properties of the treatments used. Steam activation and chemical activation show varying compositions of pore sizes. Based on the data shown and the properties of the treatments used, it would appear that the majority of the color impurities removed fall into the mesopore range between 2-50 mu.

The kinetic properties of the carbons being tested can be as important as physical properties, especially when it comes to implications on an industrial scale. Granular activated carbon (GAC) can be just as effective at removing color bodies as powdered activated carbon (PAC), but differences in contact time can be needed. GAC can benefit from increased contact time with the raw material, but eventually removed the same amount of impurities as PAC. PAC has a faster rate of adsorption but, over time, samples run with either GAC or PAC carbons showed the same color reduction. On a plant scale, this information can be used to determine whether one carbon is favored over the other on a situational basis. In terms of shipping, the C-gran could prove more useful since it would have the benefit of increased contact time during shipment. But CA1 could prove more useful in terms of duration of plant running time, where it could be beneficial to only have a shorter plant operation time.

The same reduction in color was observed with 1.5% and 5% treatments with the same carbon. An increase in dosage will decrease the time necessary, but does not actually remove any additional color impurities. Heating, vacuum, agitation, and cavitation gave no additional benefits to impurity adsorption.

The sulfur reduction potentials of:each carbon were also evaluated. Wood based, chemically activated carbons reduced more sulfur count than the F1 clay benchmark. CA1 and C-Gran reduced significant amounts of sulfur at all treatment dosages, regardless of the amount of color reduction at those dosage levels. Also, no change in sulfur count was observed with increased contact time (e.g., sulfur reduction happened quickly).

Unlike with color reduction, an increase in carbon treatment percent decreased the sulfur count. Overtime, treatments of 1.5%, 5%, and 10% carbon reduced color to approximately the same Gardner value, but the sulfur reduction increased with increasing treatment dosage of those same samples.

These trends suggest that the species causing the majority of color (>1.5 Gardner) is not sulfur based, contrary to previous beliefs. It also suggests that the species causing color below what was removed in this study (e.g., color of 1.0-1.5 Gardner) is different in shape and chemistry than the majority of the species causing higher levels of color (e.g., the >1.5 Gardner color species).

Further studies in which shipping and storage conditions were simulated, showed that over extended periods of time, the same color and sulfur reduction can be achieved using mesh tea infusers or sealed tea bags without any agitation of the sample.

### Example 4

Discussed herein are experiments that examined means of removing color impurities in crude tall oil (CTO) via treatment with various activated carbon adsorbents.

Straight CTO had a color value darker than the detectability of the Lico 150 instrument using the Gardner scale. Therefore different dilutions of CTO in toluene were tested. A dilution of 20% CTO to 80% toluene was chosen for further testing.

It was determined that the carbon treated CTO would need to be filtered to remove any impurities before an evaluation could be conducted. To see what impact filtration had on CTO, both an unfiltered and filtered sample of untreated CTO were examined. Filtration brought the color value of CTO just within measurable range on the Gardner scale (<18), reduced sulfur content, and increased GC throughput from 83.2% to 84.5% (Table 27). Extra steps were taken to identify what filtration had removed from the CTO. An FTIR analysis of CTO sediment identified lignin and sodium sulfate as the removed species. This was then confirmed by pyrolysis GC-MS.

TABLE 27
Gardner color and sulfur content of unfiltered and filtered CTO.

| | Neat Color Value | Sulfur |
|---|---|---|
| | (G) | (ppm) |
| Straight CTO | 18+ | 1110.4 |
| Filtered CTO | 17.9 | 1006.1 |

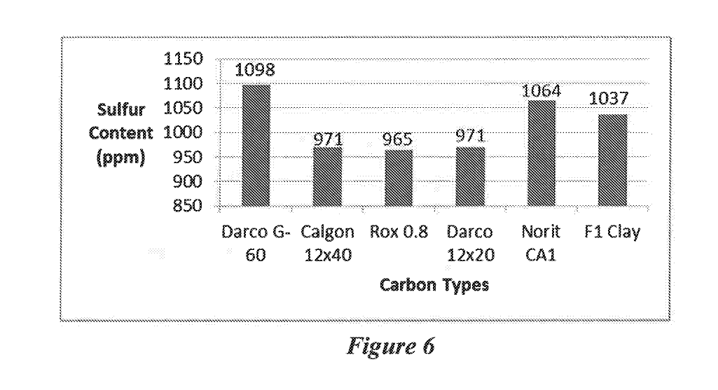

CTO samples were individually treated with 5% of six activated carbons, namely Darco G-60, Calgon 12x40, Rox 0.8, Darco 12x20, Norit CA1 and F1 clay, each of varying raw material (see Table 5). The activated carbons were placed on a hotplate for about 1 hour at 130° C. to drive off any remaining water. During that time, about 80 g of CTO was weighed into each beaker. After 1 hour, the activated carbons were transferred to tea bags and each beaker was charged with an activated carbon (open air, no heat, no agitation applied). A color sample was taken at 2 hours, 4 hours, 1 day, 4 days, and 7 days. A sample was collected at the end for sulfur analysis. For color analysis, the control sample was a 20% dilution of CTO in toluene. The results are summarized in Table 28. With this method, there was no substantial color difference between the control and the various treated CTO samples. The sulfur results from the initial carbon screening revealed that granular and extruded carbons may have better sulfur adsorption than the powdered carbons (FIG. 6).

TABLE 28
Gardner color values for CTO treated with various carbons.

| | Adsorbent | CTO | Gardner Color Value (20% in toluene) | | | | | |
|---|---|---|---|---|---|---|---|---|
| Sample | (g) | (g) | 2 Hours | 4 Hours | 1 Day | 2 Days | 4 Days | 7 Days |
| CTO (Control) | — | — | 10.4 | 10.5 | 10.6 | 10.9 | 11.1 | 11.3 |
| Darco G-60 | 4.01 | 80.3 | 10.8 | 10.6 | 10.8 | 10.7 | 10.7 | 10.8 |
| Calgon 12 × 40 | 4.06 | 80.1 | 10.8 | 10.8 | 10.7 | 10.4 | 10.8 | 10.7 |
| Rox 0.8 | 4.02 | 80.6 | 10.9 | 10.8 | 10.7 | 10.7 | 10.8 | 10.7 |
| Darco 12 × 20 | 4.02 | 80.7 | 10.9 | 10.7 | 10.6 | 10.5 | 10.7 | 10.7 |
| Norit CA1 | 4.01 | 80.3 | 10.9 | 10.6 | 10.6 | 10.7 | 10.8 | 10.8 |
| F1 Clay | 4.03 | 80.3 | 10.8 | 10.8 | 10.6 | 10.6 | 10.8 | 10.8 |

Given the results of the first screening, it was possible that a lack of heat prevented the maximum adsorption possible. So, the same procedure from the previous screening was repeated, but the samples were placed on a hotplate set at 100° C. (open air, no agitation). The results are summarized in Table 29. After the first day, color data showed degradation of the samples. Given the increasing degradation of the samples, the experiment was discontinued after 4 days.

TABLE 29
Gardner color values for CTO treated with carbons at 100° C.

Gardner Color Value (20% in toluene)

| Sample | Initial | 1 Day | 2 Days | 4 Days |
|---|---|---|---|---|
| CTO (Control) | 11.3 | 11.4 | 11.5 | 11.6 |
| Darco G-60 | 10.8 | 11.2 | 11.3 | 11.5 |
| Calgon 12 × 40 | 10.7 | 11.3 | 11.5 | 11.5 |
| Rox 0.8 | 10.7 | 11.2 | 11.4 | 11.5 |
| Darco 12 × 20 | 10.7 | 11.1 | 11.1 | 11.2 |
| Norit CA1 | 10.8 | 11.2 | 11.1 | 11.2 |
| F1 Clay | 10.8 | 10.9 | 11.0 | 11.5 |

With the results thus far, it was determined that better contact between the carbon and CTO was needed. Therefore, a new method of charging the carbon loosely in the CTO and adding agitation was examined. A trial using CA1 as the activated carbon was performed to test the new method. CA1 activated carbon was placed on a hotplate at 130° C. for ˜1 hour to drive off excess moisture. Three beakers were charged with CTO and a stir bar. After an hour, two beakers were charged directly with the loose CA1, while the remaining beaker was used as a control sample. Each beaker was placed on a stir/hot plate and agitation began. One of the beakers with CA1 was also heated to 50° C. Color samples were taken at 4 hours, 8 hours and 24 hours. The results arc summarized in Table 30. The results showed a noticeable decrease in color value (from 11.2 Gardener to 8.2 Gardner) compared to the earlier tea bag screening. Also, the results showed little difference in color values between the two temperatures, indicating that heat is not a significant factor in adsorption.

TABLE 30
Gardner color values for CTO treated with
loosely charged carbon and agitation.

| | | Color Value (20% in toluene) (G) | | |
|---|---|---|---|---|
| Sample | | 4 hours | 8 hours | 24 hours |
| CTO + CA1 | Heated to ca. 60° C. | 8.1 | 8.2 | 8.2 |
| CTO + CA1 | Room temperature | 8.5 | 8.5 | 8.2 |
| CTO (control) | Room temperature | 11.2 | 11.1 | 11.1 |

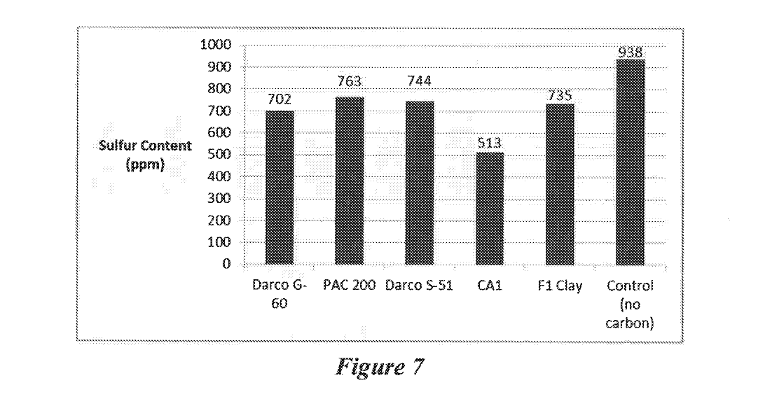

Based on the trial of the new method, CTO samples loosely charged with 10% of various powdered activated carbons (PACs) were next examined. The PACs (Darco G-60, PAC 200, Darco S-51, Norit CA1, and F1 clay) were placed on a hotplate at 130° C. for about 1 hour to drive off any excess water. PACs were chosen for ease of small scale filtration using a Whatman 0.45 μm syringe filter and a 10 mL Leur-Lok syringe. Each beaker was charged with about 50 g of CTO and a stir bar. After an hour, each beaker was charged directly with its loose activated carbon. Beakers were placed on a sit/hotplate at 50° C. and agitation began. The samples were heated to 50° C. in an attempt to decrease the viscosity of the CTO enough to ease filtration without the risk of degrading the material. Color samples were taken at 4 hours, 8 hours, 1 day, 2 days, 3 days, and 7 days. Final samples were also taken for sulfur analysis. The results are summarized in Table 31. After just four hours, color values had dropped more than the color values in Table 29 at four hours, confirming that the loosely charged carbon method was successful. The sulfur results are shown in FIG. 7. Based on the results shown in Table 31 and FIG. 7, Norit CA1 yielded the best color and sulfur reduction. Therefore, Norit CA1 was chosen as the primary PAC for later experiments with CTO.

TABLE 31
Gardner color values for CTO treated with loosely charged PAC (10%).

| | Adsorbent | CTO | Gardner Color Value (20% in toluene) | | | | | |
|---|---|---|---|---|---|---|---|---|
| Sample | (g) | (g) | 4 hours | 8 hours | 1 day | 2 days | 3 days | 7 days |
| Darco G-60 | 5.1 | 50.6 | 9.2 | 9.2 | 9.2 | 9.1 | 9.1 | 9.2 |
| PAC 200 | 5.5 | 50.5 | 11.3 | 11.1 | 10.4 | 10.2 | 10.2 | 10.1 |
| Darco S-51 | 5.2 | 50.4 | 9.3 | 9.2 | 9.0 | 9.1 | 9.1 | 9.3 |
| Norit CA1 | 5.2 | 50.2 | 8.6 | 8.4 | 8.1 | 8.0 | 8.0 | 8.0 |
| F1 Clay | 5.4 | 50.3 | 9.9 | 9.8 | 9.8 | 9.8 | 9.9 | 9.8 |
| Control^{a} | 0.0 | 50.2 | 10.6 | 10.6 | 10.7 | 10.8 | 11.0 | 11.2 |
| Standard^{b} | — | — | 11.3 | 11.3 | 10.9 | 11.0 | 11.0 | 11.1 |

^{a}The control sample was filtered and measured, but not treated with an adsorbent.
^{b}The standard sample underwent no treatment (e.g., no adsorbent, no filtration).

The next facet of adsorption that was studied was the effect of increase carbon concentration on color and sulfur reduction. Since tests at 10% had already been conducted (Table 31), CTO dosed with 20% CM was examined. The CA1 was weighed out (12.2 g) and placed on a hot plate for about an hour to drive off excess water. The beaker was charged with 60.2 g of CTO and a stir bar. After an hour had passed, the carbon was removed from the hotplate, allowed to cool for about 5 minutes and then charged to the beaker of CTO. The beaker was moved to a hot/stir plate set at 50° C. with agitation on a low setting so carbon was not dispersed into the air before it became homogenous with the CTO. Color samples were taken at 1 hour, 2 hours, 4 hours, 6 hours, and 24 hours. A final sample was taken for sulfur analysis. The results are summarized in Table 32.

TABLE 32
Gardner color values for CTO treated with 20% CA1.

| | 1 hour | 2 hours | 4 hours | 6 hours | 1 day |
|---|---|---|---|---|---|
| Gardner Color Value (20% | 6.9 | 6.4 | 6.2 | 6.0 | 6.0 |
| in toluene) | | | | | |
| Gardner Color Value (Neat) | — | — | — | — | 10.2 |

Based on the results from Table 32, CTO dosed with an even higher percentage (30%) of CA1 was examined. The CA1 was weighed out (15.1 g) and placed on a hot plate for about an hour to drive off excess water. The beaker was charged with 50.2 g of CTO and a stir bar. After an hour had passed, the CA1 was removed from the hotplate, allowed to cool for about 5 minutes and then charged to the beaker of CTO. The beaker was moved to a hot/stir plate set at 50° C. with agitation on a low setting so carbon was not dispersed into the air. Once the carbon fully homogenized in the CTO, it formed a thick paste. The paste-like consistency was too thick for agitation with a magnetic stir bar to be possible. Since this amount reached the physical limitations of the CTO, regular sampling was not possible and the entire batch was vacuum filtered. Filtration also proved slow and inefficient. The results after 7 days are shown in Table 33. After a few weeks, the sample vial had a residue of crystals forming. Based on these results, further exploration of charging larger doses of carbon to CTO would not be feasible.

TABLE 33
Gardner color values for CTO treated with 30% CA1.

| | Gardner Color value |
|---|---|
| 20% Dilution | 4.9 |
| Neat | 9.1 |

Next, the effects of mixing different adsorbents instead of using just one adsorbent were examined. First, a Dirge scale (600 g CTO) 10% CA1 treatment was conducted. The CA1 was weighed out (60 g) and placed on a hot plate for about an hour to drive off excess water. The beaker was charged with 600 g of CTO and a stir bar. After an hour had passed, the carbon was removed from the hotplate, allowed to cool for about 5 minutes and then charged to the beaker of CTO. The beaker was moved to a hot/stir plate set at 50° C. with agitation. Color samples were taken at 24 hours. The Gardner color results are summarized in Table 34.

TABLE 34
Gardner color values for large batch CTO treated with 10% CA1.

| | Gardner Color Value |
|---|---|
| 20% Dilution | 7.4 |
| Neat | 11.9 |

The large scale 10% CA1 treatment batch was then divided and subsequent treatments with 10% of various PACs were examined. The results are summarized in Table 35. Color data after the second treatment showed that CA1 performed better at color removal with the chosen method, bringing the neat color value of the CTO down to 9.8 Gardner from the original. CTO color value of 18+ Gardner (Table 27). Sulfur results confirmed that the two step treatment with CA1 had the best performance (Table 36), reducing the sulfur content to 339 ppm. These results show that mixing adsorbents was not be more beneficial than using one type of adsorbent.

TABLE 35
Gardner color values for subsequent treatments
of large batch CTO treated with 10% CA1.

| | Gardner Color Value | | Gardner Color Value |
|---|---|---|---|
| | (20% Dilution) | | (Neat) |
| Sample | 3 hrs | 3 days | Final |
| Norit CA1 | 6.1 | 5.7 | 9.8 |
| Darco G-60 | 6.9 | 6.7 | 11.4 |
| PAC 200 | 7.1 | 6.8 | 11.7 |
| Darco S-51 | 6.5 | 6.4 | 11.2 |

TABLE 36
Sulfur content of CTO samples with various carbon treatments.

| | Sulfur |
|---|---|
| Treatment | (ppm) |
| 10% CA1 | 557 |
| 10% CA1 + 10% CA1 | 339 |
| 10% CA1 + 10% Darco G-60 | 501 |
| 10% CA1 + 10% PAC 200 | 495 |
| 10% CA1 + 10% Darco S-51 | 549 |

Next, the effects of adsorption with CA1 on the product stream were examined. Another scale up treatment (5% CA1 in CTO) with a control (no carbon, but kept under same environmental conditions) was conducted. Before de-pitching, acid values and moisture content were analyzed (Table 37). In the control, filtration made no difference on the acid value, but did reduce the moisture content. The filtration of all CTO required vacuum, which accounts for the loss of moisture seen between the before and after filtration samples of the control. In the treated CTO, an increase in the acid value was observed. This can be due to the CA1 having an acidic pH level (ranging from 2.0-3.0). Sulfur content data is shown in Table 38. GC data is shown in Table 39.

TABLE 37
Initial data from 5% CA1 scale up for distillation

| | Neat Gardner | Acid Value | |
|---|---|---|---|
| Sample ID | Color Value | (mg KOH/g) | Moisture |
| Control (before filtration) | 18+ | 169.85 | 2.24% |
| Control (after filtration) | 17.9 | 169.86 | 1.73% |
| 5% CA1 (after filtration) | 14.5 | 189.89 | 1.73% |

TABLE 38
Sulfur content data from 5% CA1 scale up for distillation.

| | Sulfur |
|---|---|
| Sample ID | (ppm) |
| Control (before filtration) | 1036 |
| Control (after filtration) | 980 |
| 5% CA1 (after filtration) | 660 |

TABLE 39
GC data from 5% CA1 scale up for distillation.

| | Control | Control | 5% CA1 |
|---|---|---|---|
| | (before | (after | (after |
| Component | filtration) | filtration) | filtration) |
| LOW BOILING FATTY ACIDS | 0.4 | 0.3 | 0.4 |
| PALMITIC (C16) ACID | 3.1 | 3.1 | 3.1 |
| C17:0 FATTY ACID ISOMER | 0.1 | 0.1 | 0.1 |
| C17:0 FATTY ACID | 0.4 | 0.4 | 0.4 |
| FATTY ACID ISOMERS 1 | 0.3 | 0.3 | 0.2 |
| STEARIC (C18) ACID | 1.0 | 1.0 | 1.1 |
| ELADIC (C18:1) ACID | 0.2 | 0.2 | 0.2 |
| OLEIC (C18:1) ACID | 19.1 | 19.2 | 19.4 |
| C18:1 FATTY ACID | 0.3 | 0.3 | 0.3 |
| C19:0 FATTY ACID | 0.1 | 0.1 | 0.1 |
| C18:2 FATTY ACID ISOMERS | 0.5 | 0.5 | 0.5 |
| LINOLEIC (C18:2) ACID | 14.5 | 14.5 | 14.3 |
| PINOLENIC (C18:3) ACID | 1.0 | 1.0 | 1.0 |
| FATTY ACID ISOMERS 2 | 0.5 | 0.5 | 0.5 |
| EICOSANOIC (C20) ACID | 0.2 | 0.2 | 0.2 |
| C18:3 FATTY ACID | 0.0 | 0.0 | 0.0 |
| EICOSENOIC (C20:1) ACID | 0.3 | 0.2 | 0.2 |
| CONJ. LINOLEIC (C18:2) ACIDS | 4.2 | 4.1 | 4.4 |
| EICOSADIENOIC (C20:2) ACID | 0.5 | 0.5 | 0.5 |
| FATTY ACID ISOMERS 3 | 0.0 | 0.0 | 0.0 |
| C18:3 FATTY ACID ISOMERS | 0.2 | 0.2 | 0.2 |
| EICOSATRIENOIC (C20:3) ACID | 1.7 | 1.7 | 1.7 |
| SECODEHYDROABIETIC ACIDS | 0.0 | 0.0 | 0.0 |
| 8,15 ISOPIMARIC ACID | 0.0 | 0.0 | 0.0 |
| PIMARIC ACID | 2.5 | 2.5 | 2.5 |
| 8,15-PIMARIC ACID | 0.0 | 0.0 | 0.0 |
| SANDARACOPIMARIC ACID | 0.7 | 0.7 | 0.7 |
| ROSIN ACID ISOMERS 1 | 0.8 | 0.7 | 0.8 |
| MONO-UNSAT. ABIETIC ACIDS | 0.2 | 0.2 | 0.2 |
| PALUSTRIC ACID | 6.7 | 6.8 | 7.0 |
| 7,9,(11) ABIETIC ACID | 0.0 | 0.0 | 0.0 |
| ISOPIMARIC ACID | 2.3 | 2.3 | 2.3 |
| 13 BETA 7,9,(11) ABIETIC ACID | 0.0 | 0.0 | 0.0 |
| ROSIN ACID ISOMERS 2 | 0.1 | 0.1 | 0.1 |
| NON-CONJ. ABIETIC ACIDS PEAK(S) | 0.3 | 0.2 | 0.2 |
| DEISOPROPYL-DEHYDROABIETIC ACID | 0.0 | 0.0 | 0.0 |
| ABIETIC ACID | 10.7 | 10.8 | 11.9 |
| ROSIN ACID ISOMERS 3 | 0.0 | 0.0 | 0.0 |
| DEHYDROABIETIC ACID | 3.6 | 3.7 | 3.8 |
| NEOABIETIC ACID | 4.9 | 4.9 | 5.1 |
| POLYUNSATURATED ROSIN ACIDS | 0.2 | 0.1 | 0.1 |
| ROSIN ACID ISOMERS/NEUTRALS | 1.0 | 1.1 | 1.1 |
| Levopimaric Acid | 3.7 | 3.7 | 2.2 |
| TOTAL WEIGHT PERCENT BY GC | 86.1 | 86.0 | 86.7 |

Along with the treated CTO and its control, four other controls pulled straight from a feed drum were evaluated. The acid value for all four of those also measured around 169 mg KOH/g and the moisture content was determined to be 5.4%. The discrepancy between the moisture content of these four controls compared to the previous control before it was filtered was due to different handling processes. The previous control was kept at 50° C. with agitation and under nitrogen, which helped reduce the moisture content. These four controls had no alterations before de-pitching. The results of de-pitching are summarized in Table 40. The de-pitching involved distilling the CTO to remove the ‘distillate’, which contains both tall oil fatty acids and rosin acids. The ‘bottoms’ are the polymeric or higher boiling point components, which are heavier than typical rosin acids. The percentages refer to the yields of each of the fractions.

TABLE 40
De-pitching of CTO, filtered CTO, and 5% CA1 treated CTO.

| | bottoms | | distillate | | |
|---|---|---|---|---|---|
| | | sulfur | | sulfur | Acid |
| | % | (ppm) | % | (ppm) | Value |
| Control 1 | 16.45 | 2783 | 80.7 | 419 | 191.8 |
| Control 2 | 19.6 | 2580 | 75.0 | 418 | 188.1 |
| Control 3 | 22.2 | 2340 | 72.2 | 390 | 180.9 |
| Control 4 | 19.30 | 2585 | 74.2 | 385 | 187.1 |
| filtered control | 18.8 | 2521 | 79.1 | 401 | 173.8 |
| 5% CA1 treated | 11.3 | 2044 | 86.8 | 359 | 188.6 |

After de-pitching was complete, each distillate underwent a partial methyl esterification. This was done to increase the degrees of separation between the boiling points of TOFA and rosin for fractional distillation. The TOFA and rosin percentages from the GC data were used to calculate their respective acid value contributions in the distillate so that the esterification could be monitored by the drop in acid value. The intent was to esterify all the TOFA, but not the rosin. So, the esterification was completed once the overall acid value dropped below that of rosin's acid value contribution. The sulfur content data for the methyl esters is summarized in Table 41. The GC data for the methyl esters is summarized in Table 42.

TABLE 41
Sulfur content data for methyl ester samples.

| | Sulfur |
|---|---|
| Sample ID | (ppm) |
| 721-022 | 368 |
| 721-025 | 315 |
| 721-027 | 357 |
| 721-029 | 366 |

TABLE 42
GC data for methyl ester samples.

| Component | 721-022* | 721-025* | 721-027* | 721-029* |
|---|---|---|---|---|
| LOW BOILING FATTY ACIDS (<C16) | 0.7 | 1.1 | 0.9 | 0.6 |
| PALMITIC ACID - (C16 SATURATED) | 3.1 | 3.1 | 3.0 | 3.1 |
| FATTY ACID ISOMERS | 0.0 | 0.0 | 0.0 | 0.0 |
| C16:1 FATTY ACID | 0.3 | 0.0 | 0.2 | 0.2 |
| C17:0 and C17:0 BRANCHED ACIDS | 0.6 | 0.6 | 0.6 | 0.6 |
| FATTY ACID ISOMERS | 0.2 | 0.6 | 0.2 | 0.1 |
| STEARIC ACID - (C18:0) | 1.1 | 1.0 | 1.1 | 1.1 |
| ELADIC ACID - (trans - C18:1) | 1.1 | 1.9 | 1.5 | 1.0 |
| OLEIC ACID - (cis - C18:1) | 19.7 | 17.6 | 18.4 | 20.4 |
| C18:1 ACID ISOMERS | 0.4 | 0.3 | 0.3 | 0.3 |
| C19:0 ACID | 0.0 | 0.0 | 0.0 | 0.0 |
| C18:2 ACID ISOMERS | 1.3 | 2.0 | 1.7 | 1.4 |
| LINOLEIC ACID (c9,c12) | 14.8 | 12.5 | 13.4 | 15.1 |
| FATTY ACID ISOMERS | 0.2 | 0.2 | 0.1 | 0.1 |
| PINOLENIC ACID - (C18:3, cis-5,9,12) | 0.9 | 0.8 | 0.9 | 1.0 |
| FATTY ACID ISOMERS | 0.0 | 0.0 | 0.0 | 0.0 |
| LINOLENIC ACID - (C18:3, c9,c12,c15) | 0.2 | 0.2 | 0.2 | 0.2 |
| EICOSANONIC ACID-(C20 SATURATED) | 0.2 | 0.2 | 0.2 | 0.2 |
| FATTY ACID ISOMERS | 0.0 | 0.0 | 0.0 | 0.0 |
| EICOSENOIC ACID - (C20:1) | 0.3 | 0.3 | 0.2 | 0.2 |
| CONJ. LINOLEIC ACIDS (18:2) | 3.8 | 3.6 | 3.6 | 3.9 |
| EICOSADIENOIC ACID - (C20:2) | 0.4 | 0.5 | 0.4 | 0.4 |
| FATTY ACID ISOMERS | 0.4 | 0.6 | 0.4 | 0.3 |
| C18:3 ACID ISOMERS | 0.0 | 0.0 | 0.0 | 0.0 |
| EICOSATRIENOIC ACID - (C20:3 FA) | 1.7 | 1.5 | 1.5 | 1.7 |
| FATTY ACID ISOMERS | 0.0 | 0.0 | 0.0 | 0.0 |
| SECODEHYDROABIETIC ACID | 0.1 | 0.1 | 0.1 | 0.2 |
| 8,15 ISOPIMARIC ACID | 0.2 | 0.2 | 0.2 | 0.2 |
| PIMARIC ACID | 0.0 | 0.0 | 0.0 | 0.0 |
| 8,15-PIMARIC ACID | 0.1 | 0.2 | 0.2 | 0.1 |
| SANDARACOPIMARIC ACID | 0.1 | 0.1 | 0.1 | 0.1 |
| ROSIN ACID ISOMERS | 0.0 | 0.0 | 0.0 | 0.0 |
| MONO-UNSAT. ABIETIC ACIDS | 0.1 | 0.2 | 0.3 | 0.4 |
| PALUSTRIC ACID | 0.1 | 0.1 | 0.2 | 0.1 |
| 7,9,(11) ABIETIC ACID | 0.3 | 0.4 | 0.4 | 0.3 |
| ISOPIMARIC ACID | 0.0 | 0.0 | 0.0 | 0.0 |
| 13 BETA 7,9,(11) ABIETIC ACID | 0.3 | 0.4 | 0.4 | 0.3 |
| NON-CONJ. ABIETIC ACIDS PEAK(S) | 0.0 | 0.0 | 0.0 | 0.0 |
| ABIETIC ACID | 1.0 | 1.3 | 1.2 | 1.1 |
| ROSIN ACID ISOMERS | 0.0 | 0.0 | 0.0 | 0.0 |
| DEHYDROABIETIC ACID | 0.3 | 0.4 | 0.4 | 0.3 |
| NEOABIETIC ACID | 0.1 | 0.1 | 0.1 | 0.1 |
| POLYUNSATURATED ROSIN ACIDS | 0.0 | 0.0 | 0.0 | 0.0 |
| ROSIN ACID ISOMERS/NEUTRALS | 1.6 | 1.4 | 1.4 | 1.0 |
| TOTAL WEIGHT PERCENT BY GC | 55.7 | 53.7 | 53.6 | 56.2 |

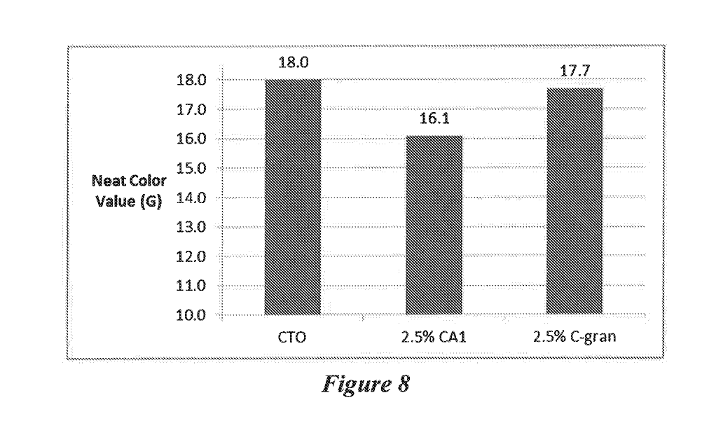

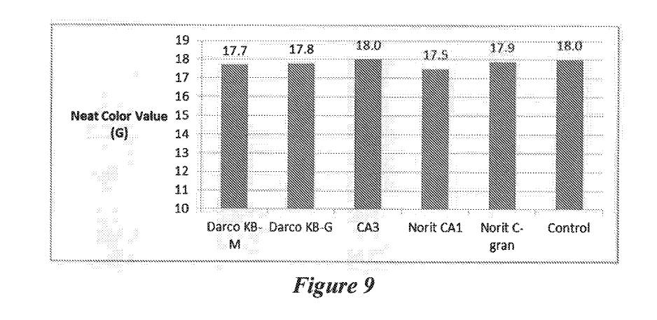

Filtering the powdered activated carbon in CTO proved difficult since it would blind the filter paper. Since CA1 and C-gran performed similarly in TOFA (Example 3), a test was run with C-gran and CA1 in CTO to see if the larger particle size would improve filtration efficiency. No effect on the filtration was observed, but the color values between the two treatments varied enough to warrant further investigation (FIG. 8). Accordingly a screening of all wood-based activated carbons was conducted on a small scale. The Gardner color results for this screening are shown in FIG. 9.

### Example 5

Carbon treated (5% by weight of CA1) tall oil fatty acids (TOFAs) were used to produce dimer acids and monomer acids. The process produced a mixture of monomer acids and dimer acids, which were separated by wipe film evaporation to the corresponding fractions. The monomer acids were evaluated using a nonpolar GC column, the results are summarized in Table 43. No significant changes in the monomer acid isomers were observed based on GC of monomer acids derived from clay bleached or carbon treated FA1. The GC results for the dimer acids are summarized in Table 44.

TABLE 43
GC data for monomer acids.

| | | | | | | | | | | 5% F1 | | Carbon | | |
|---|---|---|---|---|---|---|---|---|---|---|---|---|---|---|
| | | | | | | | | | | Clay | | Treated | | |
| | | | | | | | | | | Bleached | | (5% CA1) | | |
| GC/FID Analysis | FA1 | | | | FA2 | | | | | FA1 | | FA1 | | |
| (DB-1 column) | 1 | 2 | 3 | Avg | 1 | 2 | 3 | Avg. | B-pass | 1 | 2 | 1 | 2 | 3 |
| Lights (<C16:0) | 4.4 | 3.8 | 3.6 | | 2.9 | 3.6 | 3.3 | | 2.7 | 4.3 | 4.1 | 3.0 | 2.7 | 2.9 |
| Acids | | | | | | | | | | | | | | |
| Iso C16:0 | 0.0 | 0.0 | 0.0 | | 0.0 | 0.0 | 0.0 | | 0.0 | 0.0 | 0.0 | 0.0 | 0.0 | 0.0 |
| (branched) Acids | | | | | | | | | | | | | | |
| C16:0 (Palmitic) | 2.8 | 5.1 | 5.1 | | 2.6 | 2.6 | 2.7 | | 0.7 | 2.7 | 2.9 | 4.3 | 4.3 | 4.3 |
| Acid | | | | | | | | | | | | | | |
| Iso C17:0 | 2.2 | 2.9 | 2.9 | | 3.1 | 3.5 | 3.1 | | 1.7 | 1.8 | 1.9 | 2.4 | 2.5 | 2.4 |
| (branched) Acids | | | | | | | | | | | | | | |
| C17:0 Acid | 1.6 | 1.8 | 1.8 | | 2.0 | 2.1 | 2.0 | | 1.8 | 1.6 | 1.6 | 1.7 | 1.7 | 1.7 |
| Iso C18:1 | 18.5 | 17.8 | 17.9 | | 20.6 | 20.0 | 20.2 | | 18.3 | 17.6 | 18.0 | 17.1 | 17.8 | 16.8 |
| (branched) Acids | | | | | | | | | | | | | | |
| Iso C18:0 | 17.6 | 16.8 | 17.0 | | 20.2 | 20.0 | 19.9 | | 19.6 | 17.1 | 17.3 | 16.5 | 17.2 | 16.6 |
| (branched) Acids | | | | | | | | | | | | | | |
| Iso C18:1 Acids | 13.4 | 13.6 | 13.7 | | 13.0 | 13.3 | 12.7 | | 20.3 | 13.7 | 14.0 | 12.9 | 14.0 | 15.3 |
| Aromatic C18/ | 0.0 | 0.0 | 0.0 | | 0.0 | 0.0 | 0.0 | | 0.0 | 0.0 | 0.0 | 0.0 | 0.0 | 0.0 |
| Iso C18:1 Acid | | | | | | | | | | | | | | |
| C18:0 (Stearic) | 12.8 | 12.3 | 12.4 | | 14.5 | 14.0 | 13.6 | | 14.2 | 12.9 | 12.5 | 11.9 | 11.9 | 12.0 |
| Acid | | | | | | | | | | | | | | |
| Aromatic C18/ | 0.0 | 0.0 | 0.0 | | 0.0 | 0.0 | 0.0 | | 0.0 | 0.0 | 0.0 | 0.0 | 0.0 | 0.0 |
| Cyclic C18:1 | | | | | | | | | | | | | | |
| Acids | | | | | | | | | | | | | | |
| Aromatic C18/ | 6.2 | 5.3 | 6.0 | | 6.2 | 6.6 | 6.8 | | 6.9 | 6.6 | 6.6 | 6.1 | 7.1 | 7.4 |
| Cyclic C18:0 | | | | | | | | | | | | | | |
| Acids | | | | | | | | | | | | | | |
| Cyclic C18/ | 0.0 | 0.0 | 0.0 | | 0.0 | 0.0 | 0.0 | | 0.0 | 0.0 | 0.0 | 0.0 | 0.0 | 0.0 |
| Aromatic C18/ | | | | | | | | | | | | | | |
| Iso C19:0 Acids | | | | | | | | | | | | | | |
| Rosin Isomers/ | 0.0 | 0.0 | 0.0 | | 0.0 | 0.0 | 0.0 | | 0.0 | 0.0 | 0.0 | 0.0 | 0.0 | 0.0 |
| Aromatic C18/ | | | | | | | | | | | | | | |
| Iso C19:0 Acids | | | | | | | | | | | | | | |
| Rosin Isomers/ | 0.0 | 0.0 | 0.0 | | 0.0 | 0.0 | 0.0 | | 0.0 | 0.0 | 0.0 | 0.0 | 0.0 | 0.0 |
| Iso C19:0 | | | | | | | | | | | | | | |
| (branched) Acids | | | | | | | | | | | | | | |
| Iso C19:0 | 0.3 | 0.3 | 0.3 | | 0.4 | 0.2 | 0.1 | | 0.4 | 0.5 | 0.5 | 0.5 | 0.5 | 0.5 |
| (branched) Acids | | | | | | | | | | | | | | |
| Rosin Isomers | 3.4 | 3.3 | 3.3 | | 4.0 | 2.3 | 2.1 | | 2.9 | 4.1 | 4.0 | 5.2 | 4.4 | 4.5 |
| 3,5- | 1.5 | 1.6 | 1.7 | | 1.2 | 1.6 | 1.4 | | 1.0 | 1.0 | 1.0 | 0.9 | 0.9 | 0.9 |
| Dimethoxystilbene | | | | | | | | | | | | | | |
| C19:0 Acid | 0.6 | 0.0 | 0.6 | | 0.3 | 0.4 | 0.5 | | 0.3 | 0.5 | 0.4 | 0.5 | 0.4 | 0.5 |
| Rosin Aldehyde | 1.4 | 2.0 | 1.4 | | 0.8 | 0.8 | 1.0 | | 0.7 | 0.6 | 0.7 | 0.8 | 0.9 | 0.8 |
| Stearyl lactone/ | 2.4 | 2.3 | 2.2 | | 2.3 | 2.5 | 2.7 | | 0.7 | 0.7 | 0.7 | 1.8 | 2.0 | 1.7 |
| Oxy Acids | | | | | | | | | | | | | | |
| C20:0 Acid | 0.6 | 0.6 | 0.6 | | 0.2 | 0.5 | 0.2 | | 0.4 | 0.6 | 0.6 | 0.9 | 0.9 | 1.0 |
| Dehydroabietic | 0.9 | 0.7 | 0.7 | | 0.5 | 0.1 | 0.5 | | 0.8 | 1.0 | 0.9 | 0.5 | 0.6 | 0.6 |
| Acid | | | | | | | | | | | | | | |
| Unidentified | 5.6 | 6.0 | 5.6 | | 3.2 | 3.6 | 3.3 | | 3.3 | 6.4 | 5.7 | 5.1 | 4.8 | 5.1 |
| | | | | Avg | | | | Avg | | | | | | |
| Total | 96.3 | 96.1 | 96.7 | 96.4 | 98.1 | 97.9 | 96.2 | 97.4 | 96.5 | 93.6 | 93.4 | 92.1 | 94.7 | 94.9 |
| Iso-acids | 52.0 | 51.4 | 51.8 | 51.7 | 57.3 | 57.0 | 56.0 | 56.8 | 60.2 | 50.6 | 51.8 | 49.5 | 52.1 | 51.6 |
| Rosin/rosin | 5.7 | 6.0 | 5.4 | 5.7 | 5.3 | 3.3 | 3.6 | 4.1 | 4.3 | 5.7 | 5.6 | 6.5 | 5.9 | 5.9 |
| isomers/rosin | | | | | | | | | | | | | | |
| aldehyde | | | | | | | | | | | | | | |
| Stearyl lactone | 2.4 | 2.3 | 2.2 | 2.3 | 2.3 | 2.5 | 2.7 | 2.5 | 0.7 | 0.7 | 0.7 | 1.8 | 2.0 | 1.7 |

TABLE 44
GC data for dimer acids.

| | | | | | | | | | | 5% F1 | | 5% CA1 | | |
|---|---|---|---|---|---|---|---|---|---|---|---|---|---|---|
| | | | | | | | | | | Clay | | Carbon | | |
| | | | | | | | | | | Bleached | | treated | | |
| | FA1 | | | | FA2 | | | | | FA1 | | FA1 | | |
| | 1 | 2 | 3 | Avg | 1 | 2 | 3 | Avg | B-Pass | 1 | 2 | 1 | 2 | 3 |
| Dimer/ | 65.42 | 65.2 | 66.35 | 65.66 | 69.21 | 69.37 | 67.96 | 68.85 | 66.62 | 66.32 | 66.96 | 65.92 | 65.62 | 65.39 |
| polymer | | | | | | | | | | | | | | |
| yield | | | | | | | | | | | | | | |
| (HTGC) | | | | | | | | | | | | | | |
| Dimer | 6.6 | 6.4 | 6.2 | 6.4 | 5.9 | 5.8 | 5.8 | 5.8 | 5.8 | 5.7 | 5.8 | 6.7 | 5.5 | 6 |
| color | | | | | | | | | | | | | | |
| Dimer | 194.2 | 194.1 | 193.7 | 194.0 | 195.6 | 197 | 196.3 | 196.3 | 197.0 | 195.6 | 194.9 | 196 | 198 | 196 |
| AV | | | | | | | | | | | | | | |
| Monomer | 34.58 | 34.8 | 33.65 | 34.34 | 30.79 | 30.63 | 32.04 | 31.15 | 33.38 | 33.68 | 33.04 | 34.08 | 34.38 | 34.61 |
| yield | | | | | | | | | | | | | | |
| (HTGC) | | | | | | | | | | | | | | |
| Monomer | 1.3 | 1.2 | 1.2 | 1.2 | 0.8 | 1.0 | 0.8 | 0.9 | 0.7 | 0.6 | 0.5 | 1.1 | 0.6 | 0.5 |
| color | | | | | | | | | | | | | | |
| Monomer | 173.1 | 171.1 | 172.9 | 172.4 | 178.6 | 178.1 | 181 | 179.2 | 177.8 | 174.0 | 169.6 | 175.0 | 176.9 | 173.4 |
| AV | | | | | | | | | | | | | | |
| Iso-acids | 51.98 | 51.37 | 51.81 | 51.72 | 57.32 | 56.98 | 55.98 | 56.76 | 60.24 | 50.63 | 51.76 | 49.49 | 52.11 | 51.64 |
| Rosin/ | 5.7 | 6.0 | 5.4 | 5.7 | 5.3 | 3.3 | 3.6 | 4.1 | 4.3 | 5.7 | 5.6 | 6.5 | 5.9 | 5.9 |
| rosin | | | | | | | | | | | | | | |
| isomers/ | | | | | | | | | | | | | | |
| rosin | | | | | | | | | | | | | | |
| aldehyde | | | | | | | | | | | | | | |
| Steary | 2.4 | 2.3 | 2.2 | 2.3 | 2.3 | 2.5 | 2.7 | 2.5 | 0.7 | 0.7 | 0.7 | 1.8 | 2.0 | 1.7 |
| lactone | | | | | | | | | | | | | | |

### Example 6

### Color Stability Data

The color stability of TOFA samples was also examined. The TOFA samples were placed in a color tube that was capped with a cork and incubated at 46° C. The color was measured daily using a Dr Lange Lico colorimeter. The results for the TOFA samples are summarized in Table 45. The results for the dimer acids of TOFA are summarized in Table 46.

TABLE 45
Color stability of TOFA samples.

Total color increase after time (Gardner)

| Treatment | 7 days | 15 days | 30 days |
|---|---|---|---|
| Untreated TOFA | 2 | 2 | 2 |
| 5% clay (F1 Clay) | 1 | 2 | 3 |
| 5% PAC (CA1) | 1 | 1 | 2 |

TABLE 46
Color stability of dimer acid form of TOFA samples.

| | Total color increase after time (Gardner) | | |
|---|---|---|---|
| | 7 days | 15 days | 30 days |
| Untreated TOFA | 0.5 | 0.5-1 | 1 |
| 5% clay (F1 clay) | 0.5 | 0.5 | 1 |
| 5% PAC (CA1) | 0.5 | 1 | — |

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1-89. (canceled)

90. A method of improving the properties of a rosin-containing material comprising contacting the rosin-containing material with a mesoporous adsorbent to form a decolorized rosin-containing material wherein the mesoporous adsorbent comprises:
(a) a volume of mesopores of 0.2 mL/g or more;
(b) a volume of micropores of from 0.05 mL/g to 0.3 mL/g; and
(c) a volume of macropores of from 0.1 mL/g to 0.6 mL/g.

91. The method of claim 90 further comprising improving the color stability of a rosin-containing material to form a decolorized rosin-containing material wherein the decolorized rosin-containing material exhibits less than a 20% increase in Gardner color upon incubation at 23° C. for period of 7 days immediately following formation of the decolorized rosin-containing material.

92. The method of claim 90, wherein the rosin-containing material is selected from the group consisting of crude tall oil (CTO), tall oil rosin (TOR), distilled tall oil (DTO), crude fatty acid (CFA), and tall oil fatty acid (TOFA).

93. The method of claim 91, wherein the decolorized rosin-containing material is CTO and exhibits a Gardner color of 12 or less immediately following formation.

94. The method of claim 91, wherein the decolorized rosin-containing material is TOFA and exhibits a Gardner color of 4 or less immediately following formation.

95. The method of 90, wherein the mesoporous adsorbent comprises an activated carbon or a blend of two or more activated carbons having different average pore sizes.

96. The method of claim 90, wherein contacting the rosin-containing material with a mesoporous adsorbent comprises flowing the rosin-containing material through a stationary phase comprising the mesoporous adsorbent.

97. The method of claim 91, further comprising flowing the rosin-containing material is through the mesoporous adsorbent at a flow rate effective to reduce the neat Gardner color of the rosin-containing material by at least 20%.

98. The method of claim 90, further comprising subjecting the decolorized rosin-containing material to distillation.

99. The method of claim 90, further comprising subjecting the decolorized rosin-containing material to a reaction selected from the group consisting of esterification, disproportionation, hydrogenation, dimerization, and combinations thereof to obtain a modified rosin.

100. The method of claim 90, further comprising reducing the sulfur content of the rosin-containing material to form a desulfurized rosin-containing material wherein the rosin-containing material has a sulfur content, and wherein contacting the rosin-containing material with the mesoporous adsorbent reduces the sulfur content of the rosin-containing material by at least 25%.

101. The method of claim 100, wherein the desulfurized rosin-containing material has a sulfur content of 560 ppm or less.

102. The method of claim 100, wherein the rosin-containing material is TOFA and has a sulfur content of 40 ppm or less.

103. The method of claim 90 further comprising reducing the color of the rosin-containing material to form a decolorized rosin-containing material wherein the rosin-containing material is contacted with the mesoporous adsorbent for a period of time effective to reduce the neat Gardner color of the rosin-containing material by at least 20%.

104. The method of claim 103, wherein the rosin-containing material is CTO and the decolorized rosin-containing material exhibits a Gardner color of 12 or less immediately following formation.

105. The method of claim 103, wherein the rosin-containing material is TOFA and the decolorized rosin-containing material exhibits a Gardner color of 4 or less immediately following formation.

106. A composition comprising crude tall oil (CTO) having a neat Gardner color of 12 or less, wherein the CTO exhibits less than a 20% increase in Gardner color upon incubation at 23° C. for period of 7 days.

107. The composition of claim 106, wherein the CTO has a sulfur content of 560 ppm of sulfur or less.

108. A composition comprising a tall oil fatty acid (TOFA) having a neat Gardner color of 3 or less, wherein the TOFA exhibits less than a 20% increase in Gardner color upon incubation at 23° C. for period of 7 days

109. The composition of claim 108, wherein the TOFA has a sulfur content of 40 ppm of sulfur or less.
